(19) United States
(12) Patent Application Publication
(10) Pub. No.: US 2011/0168105 A1
(43) Pub. Date: Jul. 14, 2011

(54) PORTABLE LIVESTOCK COOLING SYSTEM

(76) Inventor: Billy Bain, Hope Mills, NC (US)

(21) Appl. No.: 13/006,302

(22) Filed: Jan. 13, 2011

Related U.S. Application Data
(60) Provisional application No. 61/294,698, filed on Jan. 13, 2010.

(51) Int. Cl. F24F 7/00; A01K 31/07; F25B 39/02

(52) U.S. Cl. 119/489; 119/493; 62/524

(57) ABSTRACT

A system for generating evaporative cooling supported by a portable means. In particular, the present invention is related to a system and method for cooling livestock during various stages of transport or relocation. A hydraulic system is ideally described that supplies cooling liquid over at least the length of a mobile carrier to utilize evaporative cooling via nozzles and fans that can be controlled all together or separately.

### CROSS-REFERENCE TO RELATED APPLICATION

The benefit of priority of U.S. Provisional Patent Application No. 61/294,698 filed Jan. 13, 2010 in the name of Billy Bain for “Portable Livestock Cooling System” is hereby claimed. The disclosure of said U.S. Provisional Patent Application No. 61/294,698 is hereby incorporated herein by reference, in its entirety, for all purposes.

### FIELD OF THE INVENTION

The present invention relates generally to a portable cooling system employing evaporative cooling. In particular, the present invention is related to a system and method for cooling livestock during various stages of transport or relocation.

### RELATED ART

The use of evaporative cooling is a rapid but safe method for cooling live animals. The transport of animals in warm climates, particularly during high seasonal temperatures, creates a variety of problems not previously resolved in the art. In particular, loading, transport, and unloading of livestock during high temperatures increases the likelihood of heat related health issues, including, but not limited to, heat stress or stroke, suffocation, and death.

Transporting poultry exacerbates the above problems due to the particular sensitivity of poultry to high temperatures. Birds are homoeothermic creatures—they produce heat to maintain a relatively constant body temperature. A five-pound chicken has the ability to produce over 50 BTUs of heat per hour and must rid itself of the same amount of heat per hour to maintain constant body temperature. The body temperature of poultry averages around 104-107° F., but will fluctuate depending upon the environmental temperature. Poultry has an easier time maintaining a constant body temperature with an environmental temperature of at least 10-15° less than its core body temperature. Moreover, there is a greater margin for error on the low temperature side, such that a chicken's body temperature in cold weather can drop as low as 73° F. before becoming fatal. There is much less flexibility, however, on the high temperature side—where an upper lethal limit on core temperature is 113-117° F. Therefore, a chicken must be able to constantly rid itself of excess body heat.

Poultry is generally raised in large specialized coops or houses (also known as broiler houses), that utilize evaporative cooling. Hundreds or even thousands of birds are kept in chicken coops at a temperature of at least 10-15° less than their core body temperature to maintain healthy and timely growth. The evaporative cooling system in the coops encompasses foggers, large fans, and/or misters. Foggers are cooling liquid systems which spray fine particles of cooling liquid into the air and bring down the ambient temperature. Through humidity controlled cooling, liquid discharge of the foggers is an ideal environment for the poultry that is sufficient for survival. Foggers coupled with fans minimize the effect of heat produced by the birds. Birds don't sweat, and therefore depend on losing heat through respiration and releasing heat from surfaces such as wattles, shanks, and unfeathered areas under the wings. Increasing air movement helps birds lose excess body heat.

While poultry is grown in a controlled environment such that the birds are not accustomed to the heat outside of the coop, they must, however, be transported to processing centers and are generally done so at their heaviest weight when they are most susceptible to heat related illnesses. Large chicken houses can easily accommodate the resources necessary for cooling instruments such as fans, foggers and the like. Transport vehicles for hauling livestock and poultry, however, are limited in space for handling such cooling instruments. While a vehicle traveling down the road generally provides adequate wind buildup inside the trailer to keep the birds cool, loading, unloading, and vehicle breakdown creates significant obstacles in maintaining the health of the birds.

Chickens to be transported to a slaughter house are generally first removed from the coop and placed together in small cages that are stacked and/or loaded atop a transport trailer. The birds are caged in very close confines, wherein the loading process generally takes about 45 minutes or more. This amount of time spent in close quarters results in a rapid increase in body temperature, particularly for birds that are experiencing the outside heat for the first time in their lives. Temperatures in many southern U.S. states during warm months can far exceed 100° F., causing numerous fatalities. On average, the DOA (“death on arrival”) rate for birds from heat related causes can be as much as 11% or more. Birds that arrive DOA are not suitable for their intended uses, particularly human consumption. Similar problems arise during unloading and when transport vehicles break down on the side of the road.

The transport of poultry ideally requires at least a transport vehicle, a vehicle to carry a loading machine or forklift, a vehicle that contains or carries a portable cooling apparatus, and a portable toilet for the workers employed in the catching and loading process since many farms that raise such animals (e.g., poultry) do not have readily accessible and/or public toilet facilities. If these systems can be minimized to two or even one vehicle, the costs and savings in labor over the present systems could be substantial.

Attempts have been made to address cooling problems. Sullivan et al. (U.S. Pat. Nos. 6,546,743 & 6,796,136) discloses a mobile evaporative cooling apparatus on a van-type trailer with fans and misters that expel water into a mixing chamber for being drawn into the air stream of the back of electric fans out towards the intended target. There are numerous problems with this design. First, the use of electric fans necessitates a strong electric power source that is generally less powerful than hydraulic fans. Moreover, having water propelled into and through an electric fan is an inherent hazard, in addition to creating an environment where the electric fan motor corrodes and deteriorates rapidly over time. Second, the necessity of having an encased mixing chamber takes up the entirety of available space on the cooling trailer, and does not allow for additional equipment needed on sight during the loading of poultry, such as water tanks for the system, a portable toilet for the workers, or the capacity to load a forklift onto the trailer. Third, the fan positioning of the trailer in Sullivan et al. does not provide a coverage area greater than the length of the trailer, such that it must be parked close to perfectly in line with the trailer to be loaded with livestock.

Similarly, Maynor (U.S. Pat. No. 6,382,141) calls for the use of electric fans and teaches away from using spraying systems that propel water directly onto the animals. In addition, the design of Maynor's trailer is not large enough to carry sufficient water for the process, instead relying on a water supply at the location where the system is to be utilized Likewise, the trailer doesn't have the coverage capacity, nor would it be able to include a portable toilet for the workers or accommodate a forklift

Additionally, a Koolchick system by Techno-Catch LLC (www.chickencatcher.com/koolchick.cfm) provides a fan system utilizing evaporative cooling with hydraulic power, but fails to provide the expansive coverage that is desired, provides only four 8-foot fans with a mere 100,000 CFM, has a limited sprayer coverage that would be incapable of soaking the poultry, fails to include a separate hydraulic connection system for each fan, and fails to provide for angled fans to create an ambient gas environment of evaporative cooling the length of such system. Moreover, the Koolchick system fails to include many additional features and advantages of the present system.

In consequence, the art continues to seek improvements in means for transporting and loading livestock, with particular attention to poultry, such that heat related health issues are decreased or avoided. While the teaching of the above cited art fails to provide the advantages of the present system, the above cited references are incorporated herein by reference. The embodiments of the present invention, methods and systems disclosed herein, that create solutions to the problems raised above.

### SUMMARY

The present invention relates to portable cooling systems employing evaporative cooling. In particular, the present invention is related to a system and method for cooling livestock during various stages of transport or relocation.

In one aspect, the invention relates to equipping one or more fans with cooling liquid propulsion devices or misters that deliver a quantity of cooling liquid or mist into the air propelled from the fan and onto the livestock. As cooling liquid collects on the livestock or birds and thereafter evaporates as a result of the air flow, the resulting convection rapidly and safely reduces the temperature while absorbing the thermal energy emanating from the birds.

In another aspect, fans with cooling liquid propulsion devices are used to thoroughly soak the birds and keep them wet in anticipation of the air that will pass through the trailer during transport wherein convection keeps the birds cool while the transport vehicle is in motion.

In a further aspect, the invention relates to a plurality of fans that run along a flat-bed trailer, wherein the fans are equipped with water misters for the convection cooling process. The fans on each end of the trailer are angled outward to extend the coverage area. The trailer is pulled next to the livestock transport trailer to keep the animals cool during the loading/unloading process, where the core temperature of the birds may peak. Since the fans on each end are angled, the cooling system trailer need not be pulled exactly along side and in-line with the transport trailer.

In a further aspect, the invention relates to a single livestock transport trailer that includes a self-contained evaporative cooling mechanism with fans and cooling liquid misters. The fans in this aspect of the invention would be thinner relatively than those depicted in other aspects and would be along one side of a transport trailer extending along the edge in such a manner as to minimize the space taken up on the trailer. Additionally, this aspect of the invention would likely include cooling liquid storage tanks under the trailer. Moreover, the hydraulic power may be supplied via the transport truck that drives the trailer, allowing for additional space for the poultry cages to be loaded onto the transport trailer without the loss of space relative to conventional transport trailer. Finally, as an additional option, the fans may be allowed to stick out a width from the side of the trailer, generally not beyond the scope of the outside extended side minors of the truck, so has to avoid implication of most states' wide-load specifications, but to allow greater storage space on the trailer itself. This system would allow for evaporative cooling during travel and truck break downs, in addition to the loading and unloading steps. A forklift could still be loaded on the rear of the trailer, but there would not likely be adequate space for a portable toilet absent the sacrifice of additional space for the poultry cages.

A further aspect of the invention relates to a cooling system with one or more fans, an engine for powering the system, a hydraulic pump for driving power from the engine to the fans, a cooling liquid source, a cooling liquid pump, misters, and controls for running the system.

Another aspect of the invention relates to self-contained livestock transport and cooling device that includes fans, hydraulic pump for powering the fans, cooling liquid source, cooling liquid pump, misters, and controls for running the system, all of which are powered by the engine of the transport vehicle or truck.

A still further aspect of the invention relates to a fully mobile system, incorporating one or more fans, an engine for powering the system, a hydraulic pump for driving power from the engine to the fans, a cooling liquid source, a cooling liquid pump, misters, controls for running the system, a gate surrounding the back of the fans, a fold-down ladder that provides access to the portable toilet and maintenance area, and a maintenance access door that is equipped with a trip switch to be engaged when opened to stop the fans for safety reasons.

A still further aspect of the invention relates to a fully mobile system, incorporating one or more fans, an engine for powering the system, a hydraulic pump for driving power from the engine to the fans, a cooling liquid source, a cooling liquid pump, misters, controls for running the system, and optionally including a canopy for covering the livestock transport vehicle to shield the livestock from direct sunlight.

A still further aspect of one embodiment of the invention provides a strong sprayer piping system capable of withstanding the high wind velocity of the fans as the sprayer piping is placed on the face of the fan cage. Such placement avoids the potential damage or deterioration over time to the fan motor or blades as a result of the water exposure from the sprayers, foggers, or misters placed behind the fans. Likewise, the piping would ideally handle high pressure cooling liquid and accommodate both missing nozzles for evaporative cooling, fogger nozzles for the same but at a lighter liquid load, and sprayer (also referred to a “soaker nozzles”) nozzles for soaking the poultry such that the fluid continues the evaporative cooling process while the transport trailer is in transit.

A still further aspect of one embodiment of the invention provides for a hydraulic system to avoid the problems associated with electric fan motors, but which also optionally includes quick disconnect couplers to disable any one fan separately for service or removal. Likewise, one embodiment of the system may include a multiple hydraulic control which operates each fan individually through one control manifold.

A still further aspect of one embodiment of the invention provides a portable cooling system, comprising: a mobile carrier; at least one motive ambient gas driver generating in operation an ambient gas flow stream, wherein said at least one motive ambient gas driver is mounted on the carrier; a motor for driving the at least one motive ambient gas driver; a power source for driving the motor; and a liquid source arranged to supply liquid to an air stream generated in operation of said at least one motive ambient gas driver.

A still further aspect of one embodiment of the invention provides a portable cooling system, comprising: a mobile carrier; at least one fan mounted on the carrier; a motor for driving the at least one fan; a power source for driving the motor; and a liquid source arranged to supply liquid to an air stream generated in operation of said fan.

A still further aspect of one embodiment of the invention provides a method of transporting poultry comprising: providing a mobile cooling system mounted on a mobile carrier, the mobile cooling system comprising a motor for driving the at least one motive ambient gas driver; a power source for driving the motor; a liquid source arranged to supply liquid to an air stream generated in operation of said at least one motive ambient gas driver; and activating the mobile cooling system in proximity to the poultry.

A still further aspect of one embodiment of the invention provides a method of reducing poultry loss incident to heat during transport, comprising: providing a mobile cooling system mounted on a mobile carrier, the mobile cooling system comprising a motor for driving the at least one motive ambient gas driver; a power source for driving the motor; a liquid source arranged to supply liquid to an air stream generated in operation of said at least one motive ambient gas driver; and activating the mobile cooling system during loading and unloading of said poultry.

Other aspects, features and embodiments of the invention will be more fully apparent from the ensuing disclosure and appended claims.

### BRIEF DESCRIPTION OF THE DRAWINGS

FIG. 1 is a photograph of one embodiment of the portable cooling system viewed from the side upon which air and cooling liquid is propelled outward or towards and to the right of the viewer.

FIG. 2 is a photograph of one embodiment of the portable cooling system at a front angled view.

FIG. 3 is a photograph of one embodiment of the portable cooling system viewed from the side upon which air and cooling liquid is propelled directly toward the viewer.

FIG. 4 is a photograph of one embodiment of the portable cooling system viewed from the rear.

FIG. 5 is a photograph of one embodiment of the portable cooling system viewed from the rear and below the fans, revealing the cooling liquid supply piping.

FIG. 6 is a photograph of one embodiment of the portable cooling system viewed from the back side from which air and cooling liquid is blown away from the viewer.

FIG. 7 is another photograph of one embodiment of the portable cooling system viewed from the back side.

FIG. 8 is a photograph of one embodiment of a fold-down ladder that provides access to the portable toilet and maintenance area.

FIG. 9 is a photograph of one embodiment of the hydraulic storage tank and lines leading to the hydraulic control lever on the right.

FIG. 10 is a photograph of one embodiment of the hydraulic control lever as depicted in FIG. 9.

FIG. 11 is a photograph of one embodiment of the engine with throttle control and the engine control center.

FIG. 12 is a photograph of one embodiment of the engine control center with various gauges and buttons.

FIG. 13 is a photograph of one embodiment of the engine fuel tank and battery compartment.

FIG. 14 is a photograph of one embodiment of the cooling liquid storage tank.

FIG. 15 is a photograph of one embodiment of the cooling liquid pump.

FIG. 16 is a photograph of one embodiment of the portable toilet and the hydraulic fan motor plumbing for powering the fans.

FIG. 17 is a photograph of one embodiment of the hydraulic fan motor and hydraulic lines connected to the fan motor for powering the fans.

FIG. 18 is a photograph of one embodiment of the folding ICC bumper that provides access for loading a forklift on the back of the trailer.

FIG. 19 is a top-down schematic illustration of one embodiment of the portable cooling system.

FIG. 20 is a back side schematic illustration of one embodiment of the portable cooling system.

FIG. 21 is another top-down schematic illustration of one embodiment of the portable cooling system revealing the cooling liquid lines.

FIGS. 22A-C are schematic illustrations of various embodiment of the sprayer piping and nozzle placement of the portable cooling system.

FIG. 23 is a schematic of a single hydraulic control which operates all fans with one control manifold.

FIG. 24 is a schematic of a multiple hydraulic control which operates each fan individually through one control manifold.

FIG. 25 is an electrical wiring schematic one embodiment which operates the system's engine maintenance and safety shut-off relays.

FIGS. 26A-C are schematics of the relays to stop the system or shut down the engine that runs the system.

FIG. 27 is a schematic of the hydraulic lines, motors and controls of one embodiment of the present system.

FIG. 28 is a schematic of the hydraulic fan motor and lines of the present system.

FIG. 29 is a schematic drawing of another embodiment of the present system that employs sliding canopies to reduce thermal exposure to sunlight.

### DETAILED DESCRIPTION

The present invention relates to a portable cooling system employing evaporative cooling. In particular, the present invention relates to a system and method for safely cooling humans or animals and in particular, livestock during various stages of transport or relocation.

The advantages and features of the invention are further illustrated with reference to the following examples, which are not to be construed as in any way limiting the scope of the invention but rather as illustrative of one or more embodiments of the invention in specific applications thereof. Referring in more detail to the figures, wherein reference numbers indicate like parts throughout each figure.

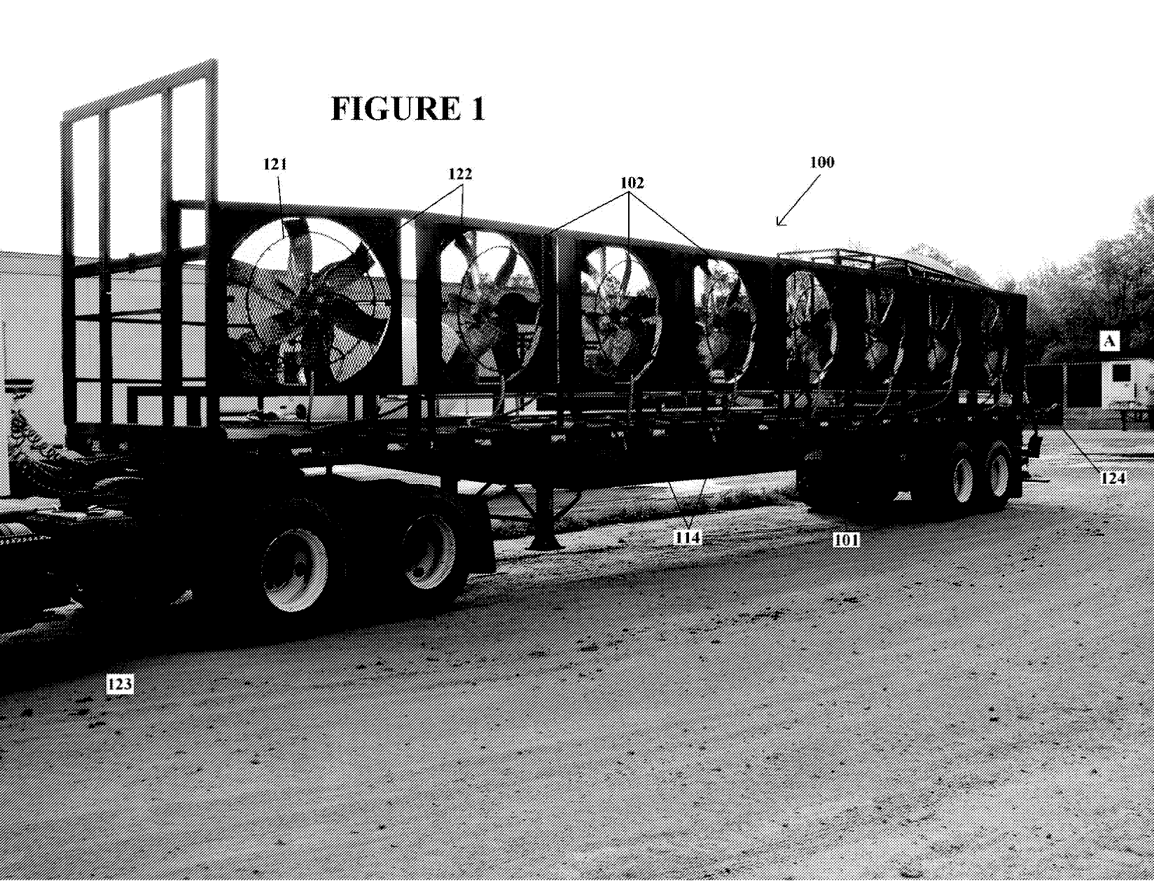

FIG. 1 is a photograph of one embodiment of the portable cooling system 100 mounted on a cooling system trailer 101 with a forward 123 and rear 124 sections and viewed from the front side upon which air and cooling liquid is propelled outward or towards and to the right of the viewer in the general direction A with a breadth of flow covering at least the length of the cooling system trailer 101 from front 123 to back 124, with the fan 102 closest to the front 123 angled forward and the fan 102 in the back 124 angled towards the rear. The angled fans create an even broader breadth of flow such that any transport trailer need not be parked directly beside the cooling system trailer 101. FIG. 1 reveals the front face of several fans 102 with the cooling liquid sprayer piping 121 on the face cage of each fan 102. The piping 121 includes a series of nozzles 115 for delivering cooling liquid into the flow or air generated by the fans 102. Each fan has a plurality of fan blades 122. The piping 121 is supplied with cooling liquid, ideally water, by the cooling liquid supply lines 114.

A 48 or 53 foot flat bed or drop deck trailer may be used, although with some rural road restrictions, the 48 foot trailer may be more practical. Such a 48 foot or greater sized trailer is ideal for covering an equal length poultry transport trailer, but is benefitted by the expansive fan system in one embodiment that includes non-parallel end fans relative to the middle fans to provide broader coverage than parallel fans. Fans ideally may be facing the (left) driver's side (“front side”) of trailer for poultry loading areas but can be configured in different ways for other applications. Moreover, each component of the system 100 can be located anywhere on the trailer for the operator's convenience. The trailer 101 can be used to cool livestock on the farm, in barns, or in the loading areas. The trailer can also be used to cool large crowds of people such as outdoor concerts or water parks. The fan trailer can be configured in many different ways to accommodate a user's needs.

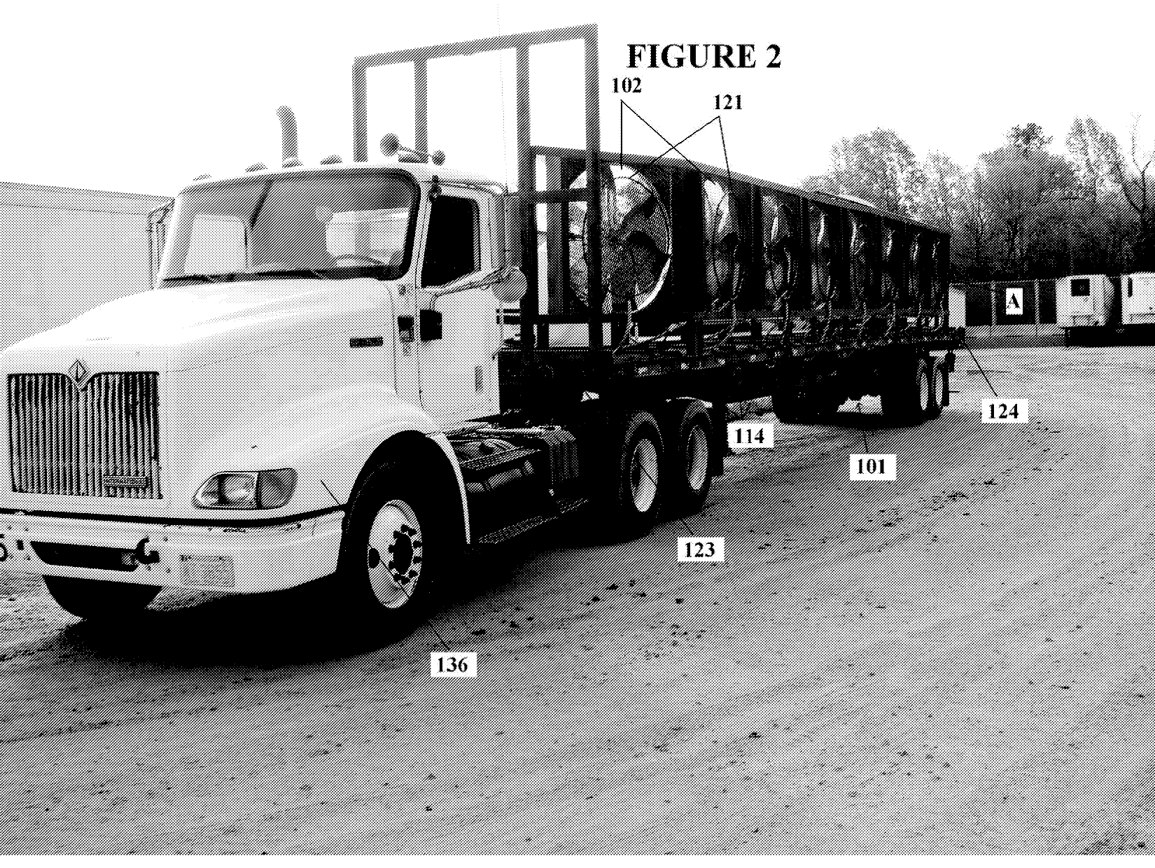

FIG. 2 is a photograph of one embodiment of the portable cooling system at an angled view from the front side upon which air and cooling liquid is propelled outward and to the right of the viewer in the general direction A, revealing the front face of several fans 102 with the cooling liquid sprayer piping 121 on the face cage of each fan 102. A truck 136 is connected to and transports the trailer 101 that supports the portable cooling system 100. Note that the first fan 102 towards the front of the trailer 123 is angled more towards the viewer and the front of the trailer 123 to increase the coverage area of the fans and liquid. The rear fan 102 positioned at a similar but opposite facing angle towards the rear of the trailer 124 for the same reason. Both fans 102 in the front 123 and rear 124 are in non-parallel fashion relative to the remaining fans 102. In a further embodiment, such end fans may be arranged to change such angles, wherein the fans are installed on pivotal mounts that may be mechanically, manually, or electronically controlled. Such change in direction of the end fans, or any other fans in various embodiments, allows for an adaptive coverage area depending upon the desires of the user.

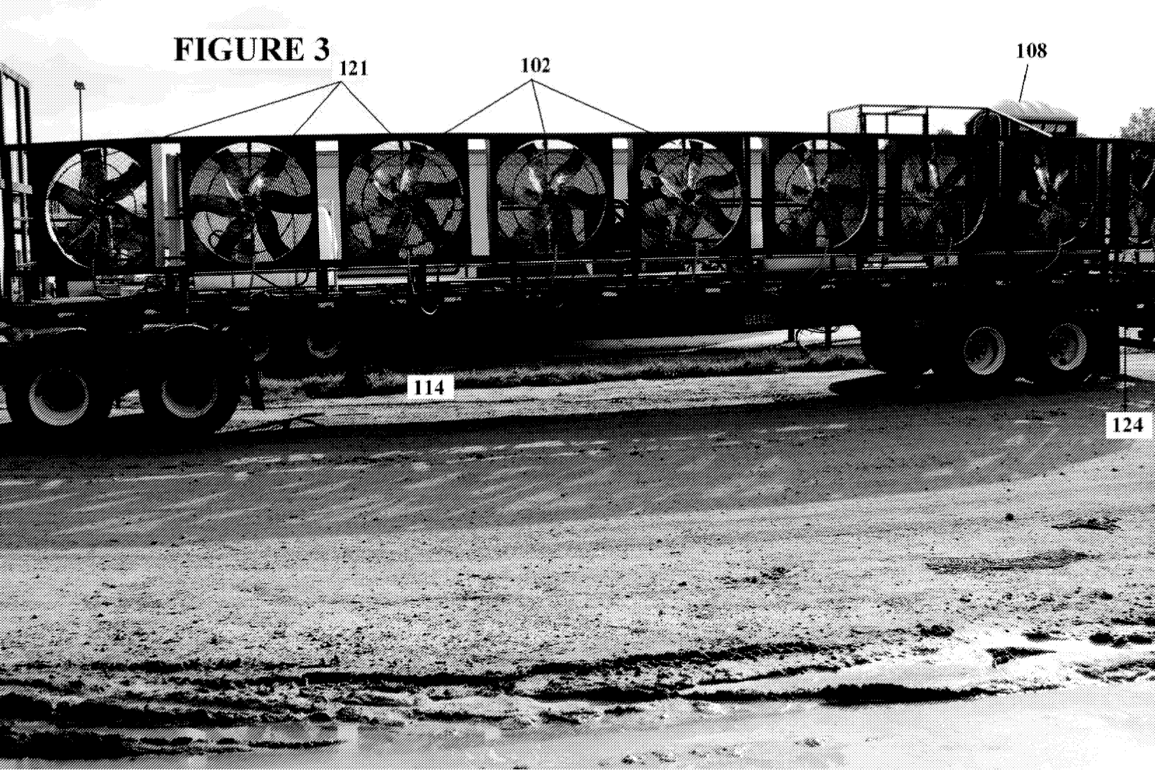

FIG. 3 is a photograph of one embodiment of the portable cooling system viewed from the front side upon which air and cooling liquid is propelled directly toward the viewer, revealing the front face of several fans 102 with the cooling liquid sprayer rings 121 on the face cage of each fan 102. The cooling liquid supply lines 114 are also revealed in FIG. 3. The top of the portable toilet 108 is revealed behind the fans 102 near the rear of the trailer 124.

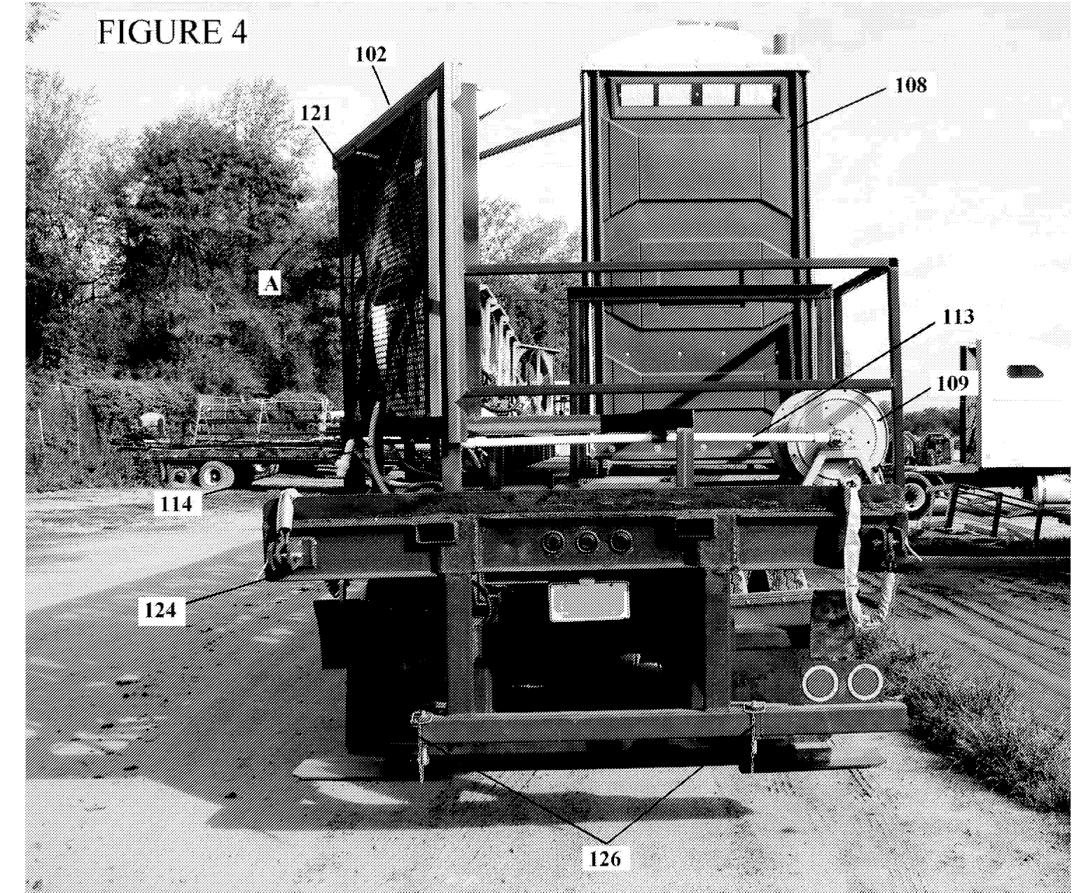

FIG. 4 is a photograph of one embodiment of the portable cooling system viewed from the rear of the trailer 124 upon which air and cooling liquid is propelled toward the left in direction A, revealing a portable toilet 108 and cooling liquid supply hose reel 109 that supplies cooling liquid to the system via supply line 113. The hose reel 109 can refill the forward mounted or side mounted cooling liquid tanks 103 to insure long operational periods with minimal transportation of cooling liquid or to allow supply of cooling liquid at the location where the system is to be used. A portion of the cooling liquid supply lines 114 are also revealed below the fans 102. Additionally, the bottom ICC bumper 126 folds in on each side to allow access for loading a forklift on the rear of the trailer 124 such as a Moffitt forklift. Note the piping inserts 153 to allow insertiong of the forklift forks. The inserts 153 are reinforced as shown in FIG. 43, where the dimensions are supplied for this embodiment in FIG. 52.

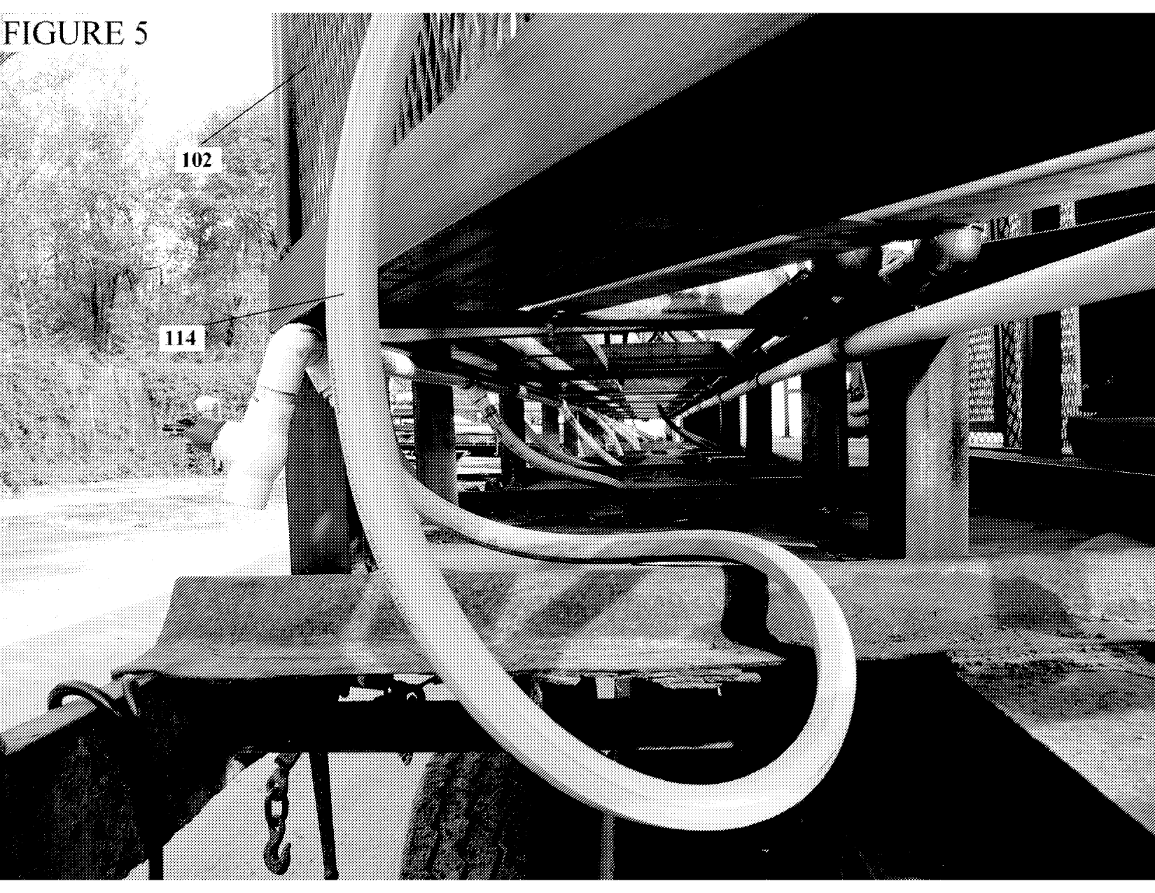

FIG. 5 is a photograph of one embodiment of the portable cooling system viewed from the rear of the trailer 124 and below the fans 102, revealing the cooling liquid supply piping 114. The piping delivers cooling liquid to the cooling liquid sprayer piping 121 and out a series of nozzles 115, wherein the flow of liquid is carried by the flow of air driven from the fans 102 to effectuate evaporative cooling. The piping ideally may be separately turned off or disconnected for each fan in case maintenance is required, or for any other reason desired to disable one or more fans separately from the group.

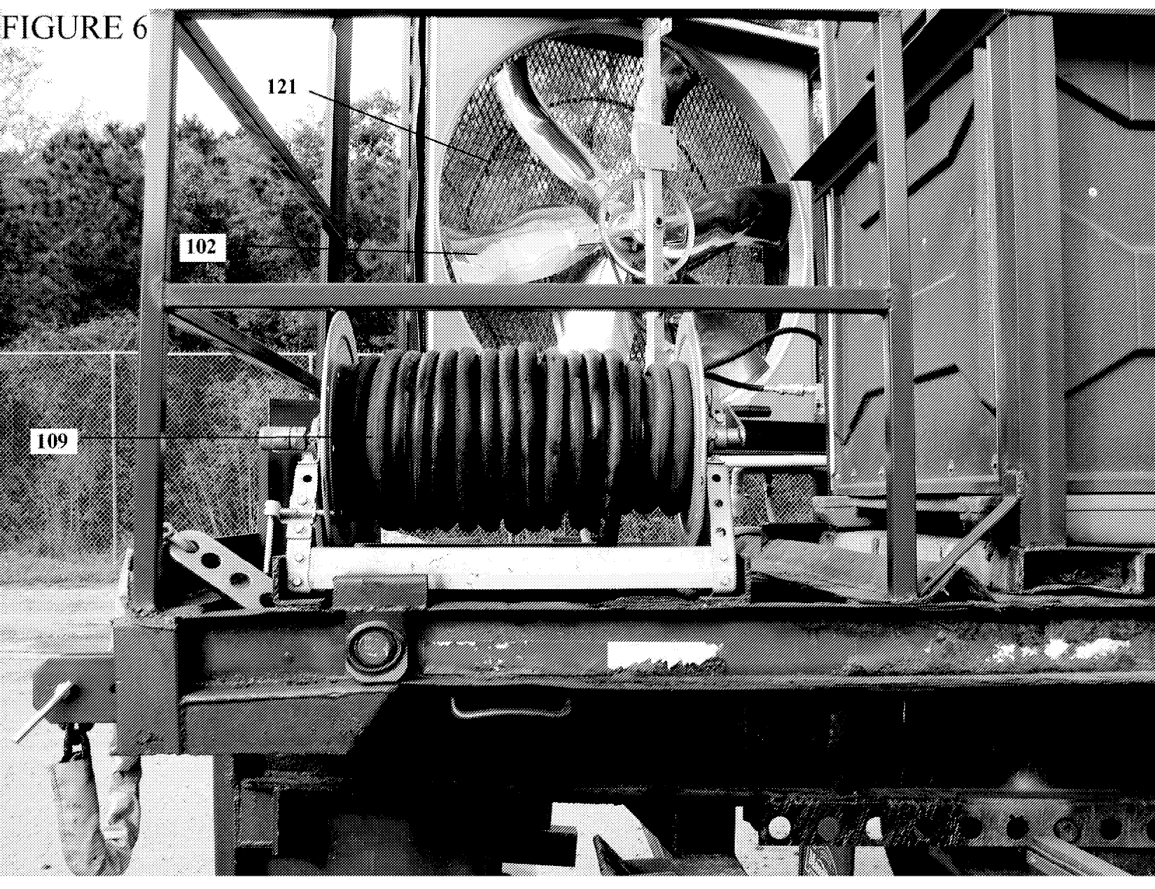

FIG. 6 is a photograph of one embodiment of the portable cooling system viewed from the back side from which air and cooling liquid is blown away from the viewer, revealing the cooling liquid supply hose reel 109 and the back of one fan 102 viewed above the hose.

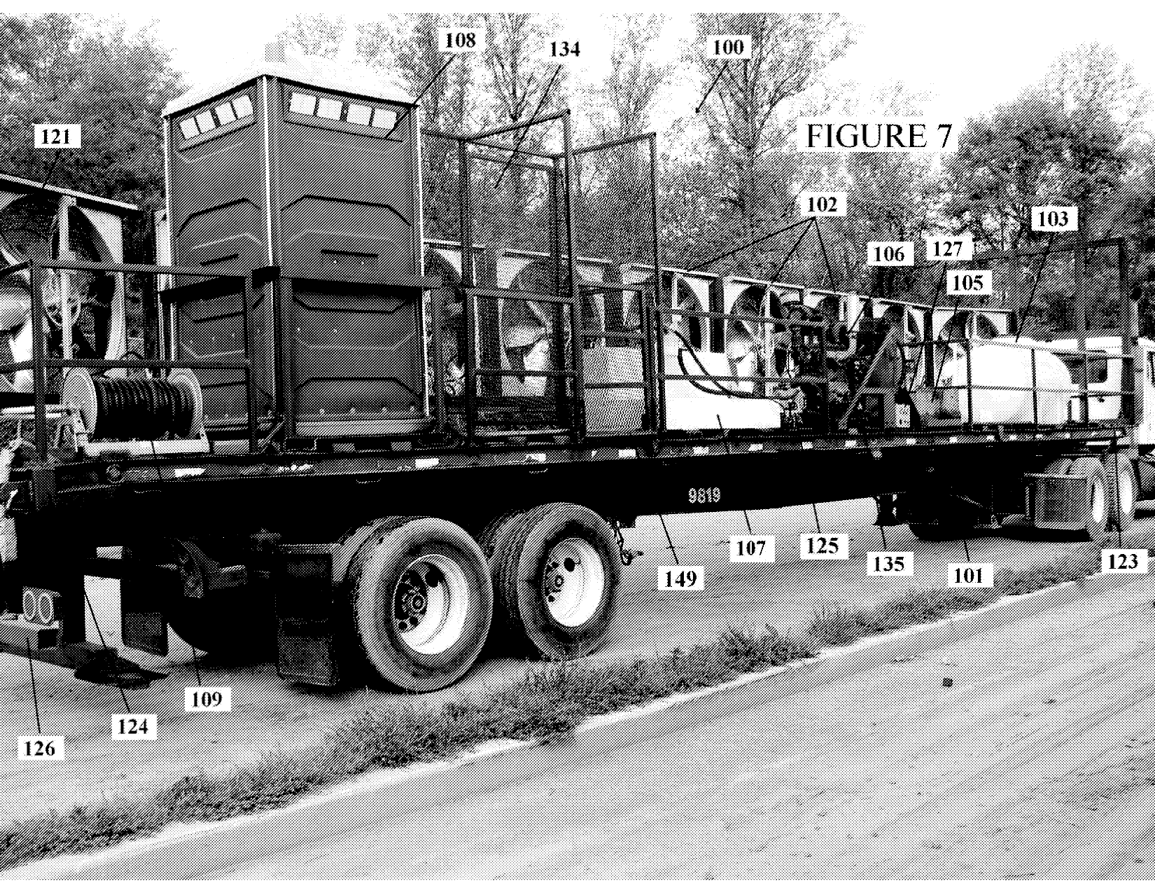

FIG. 7 is a photograph of one embodiment of the portable cooling system viewed from the back side from which air and cooling liquid is blown away from the viewer, revealing from left to right, the first of several fans 102 viewed from the back, the sprayer piping 121, the cooling liquid supply hose reel 109 towards the rear of the trailer 124, the portable toilet 108, a maintenance area entry gate 134 for access to the maintenance area and back of the fans 102, a fold-down ladder 149 that provides access to the portable toilet 108 and maintenance area entry gate 134, a hydraulic storage tank 107, a hydraulic control lever 125, a diesel engine 106 with throttle control 135, an engine control center 127 with various gauges, a diesel fuel tank and battery housing 105, an engine start button 132, a cooling liquid holding tank 103 towards the front of the trailer 123, and the truck 136 that is connected to and transports a trailer 101 that supports the portable cooling system 100. Note that all the controls are within relative proximity to each other.

On a system that has fans on a transport trailer, the controls for the system will likely be within the truck since the truck will power the system. Such a system could still have the capacity for loading a forklift on the rear, tanks below the trailer and the fans along one side of the trailer in a much thinner fashion, possibly extending the width of the trailer. A portable toilet would not likely fit on such a system.

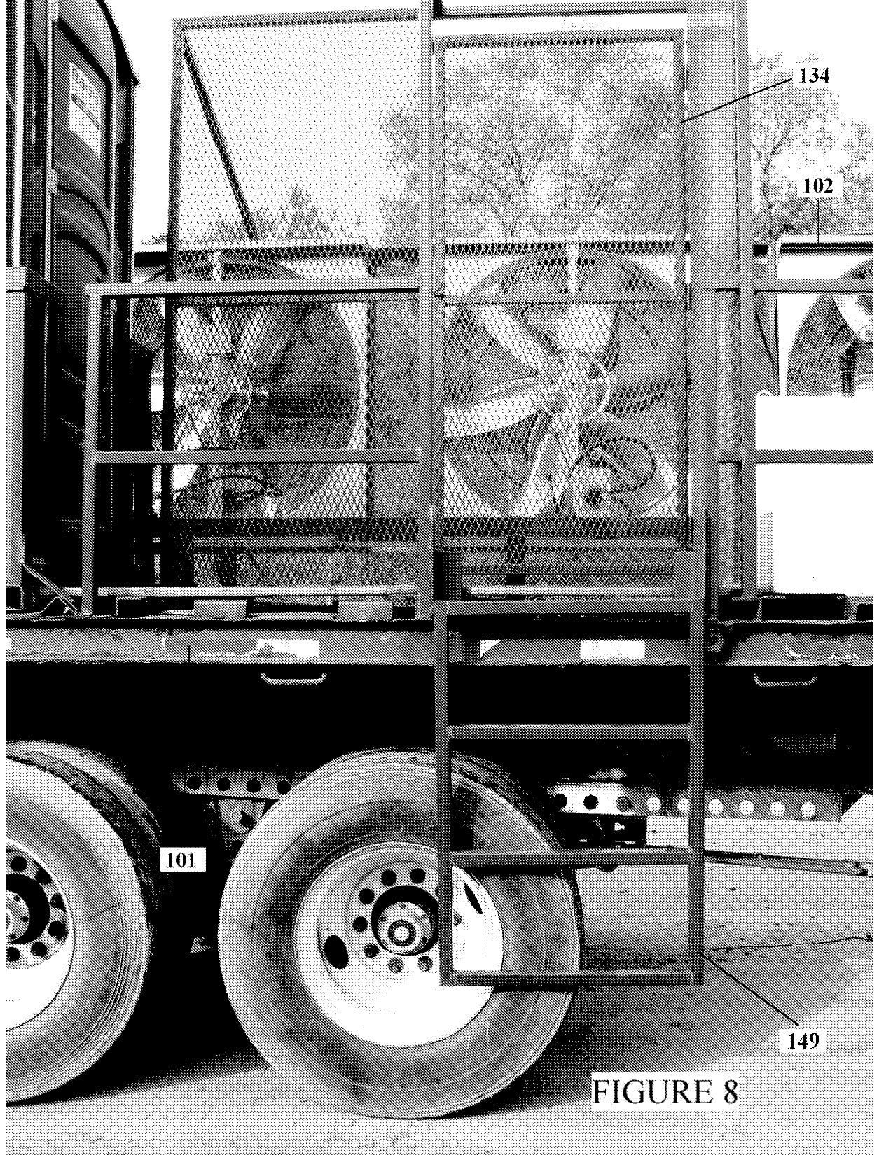

FIG. 8 is a photograph of one embodiment of the portable cooling system viewed from the side from which air and cooling liquid is blown away from the viewer, revealing the fold-down ladder 149 and maintenance gate 134, wherein the maintenance gate 134 is equipped with a trip switch to stop the fans 102 when the gate 134 opened for safety reasons.

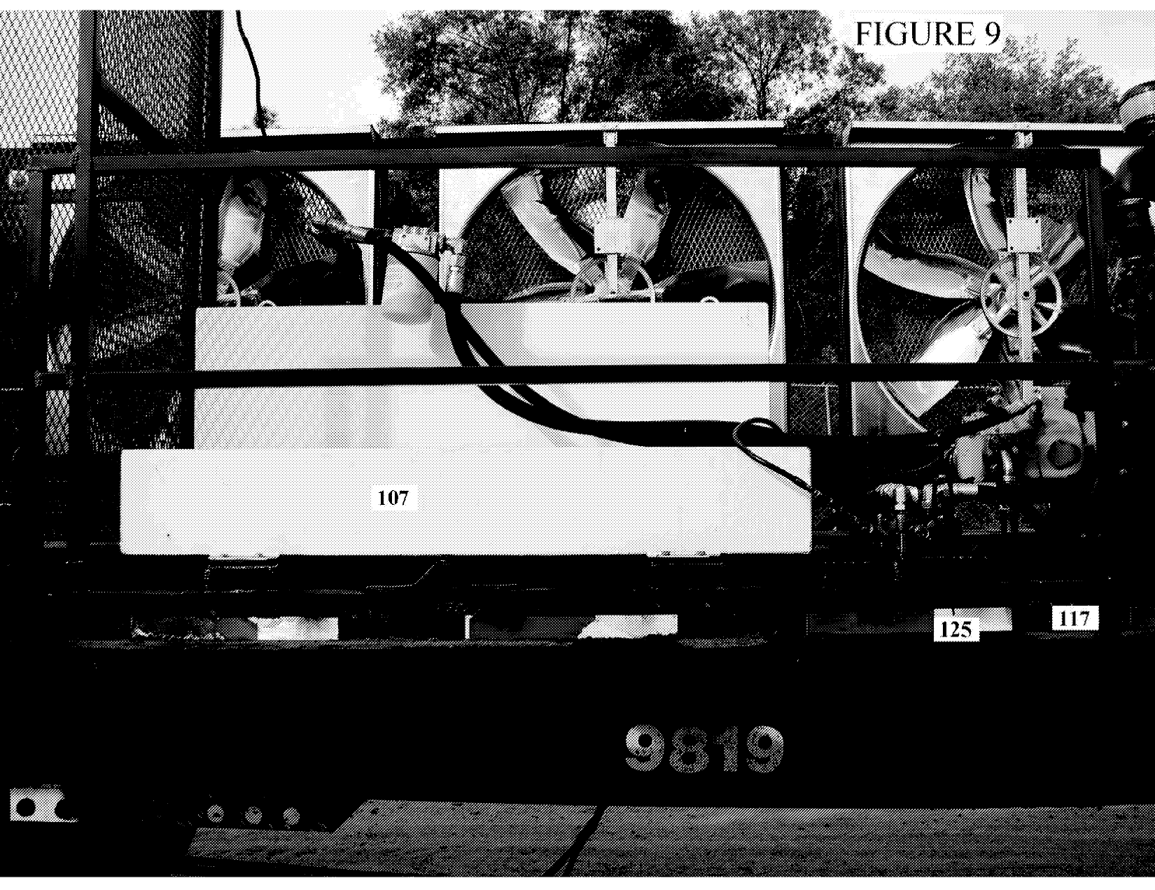

FIG. 9 is a photograph of one embodiment of the portable cooling system viewed from the side from which air and cooling liquid is blown away from the viewer, revealing on the hydraulic fluid storage tank 107 with hydraulic lines 137 leading to the hydraulic control lever 125 and the hydraulic pump 117 that is attached to the engine 106.

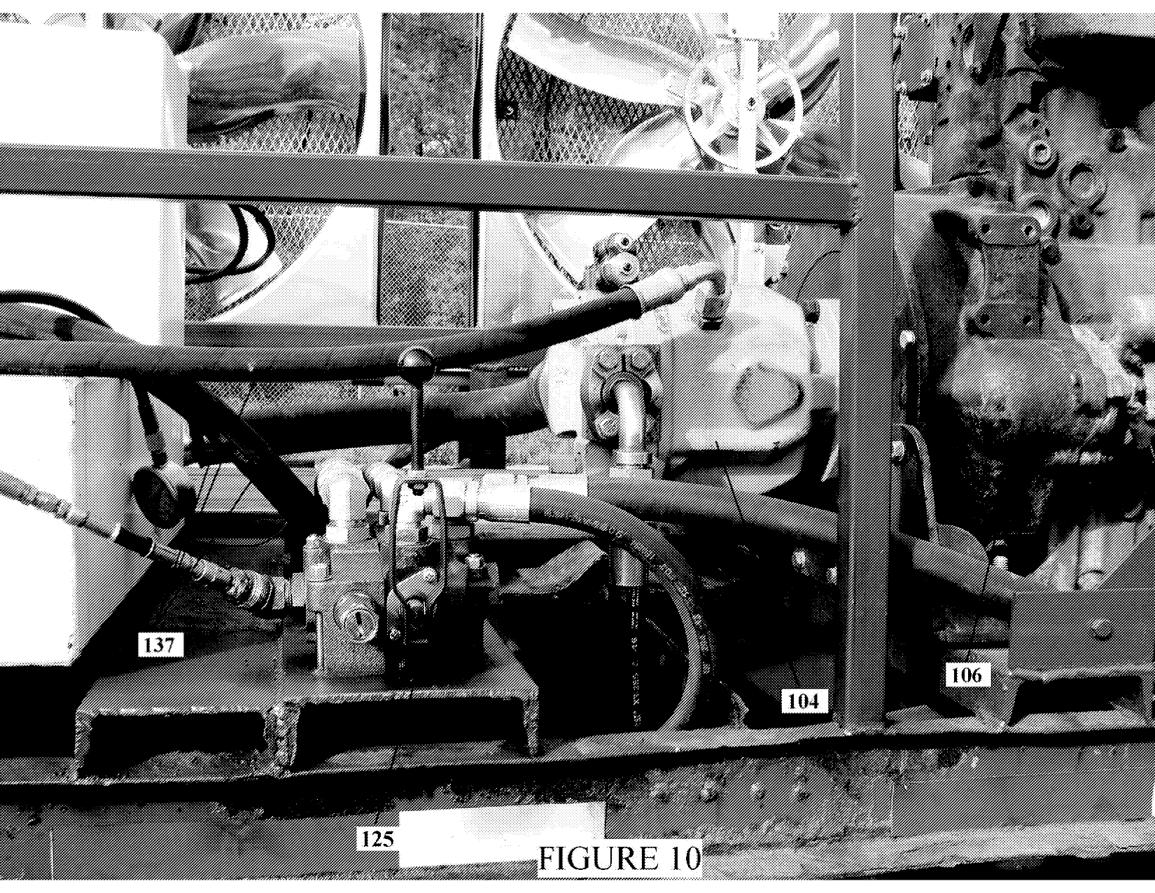

FIG. 10 is a photograph of one embodiment of the portable cooling system viewed from the side from which air and cooling liquid is blown away from the viewer, revealing a closer view of the hydraulic control lever 125, the hydraulic lines 137. hydraulic pump 104, and the engine 106.

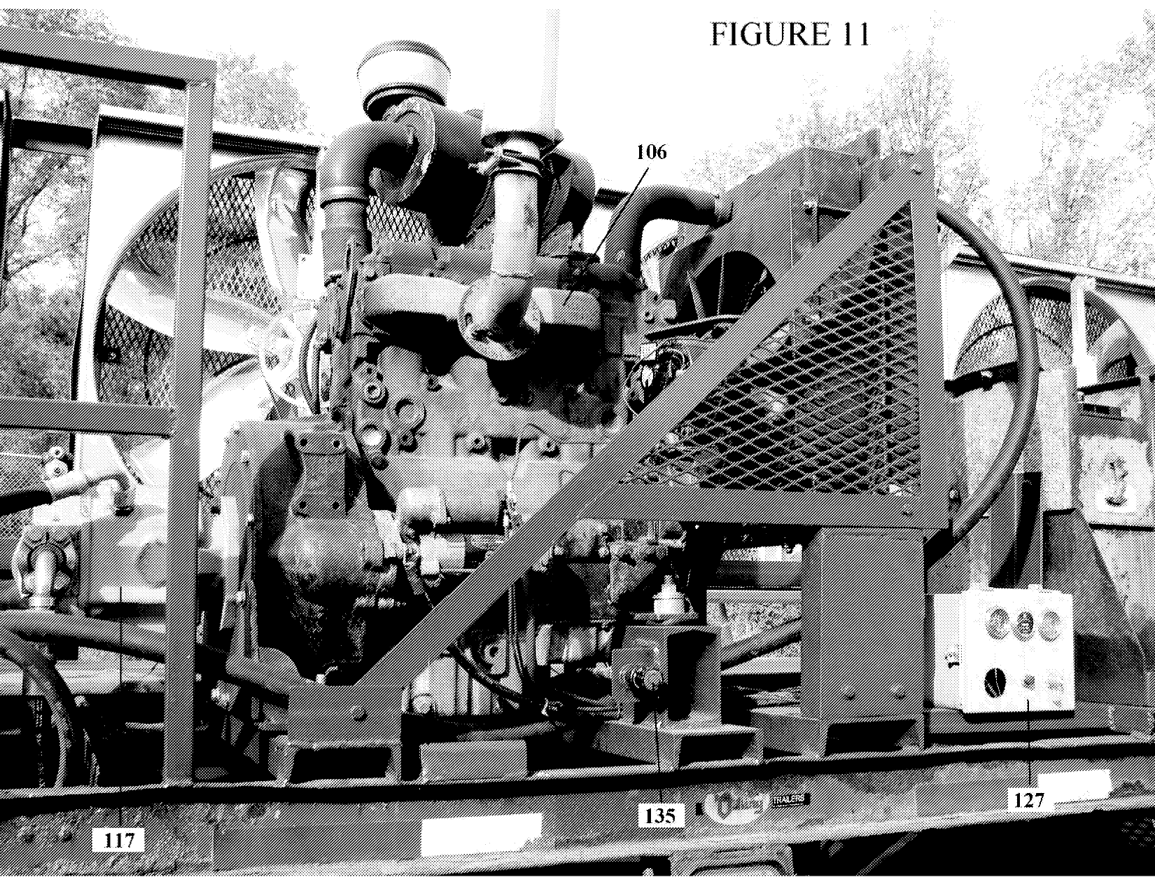

FIG. 11 is a photograph of one embodiment of the portable cooling system viewed from the side from which air and cooling liquid is blown away from the viewer, revealing the diesel engine 106 with throttle control 135, the hydraulic pump 117, and on the right the engine control center 127 with various gauges.

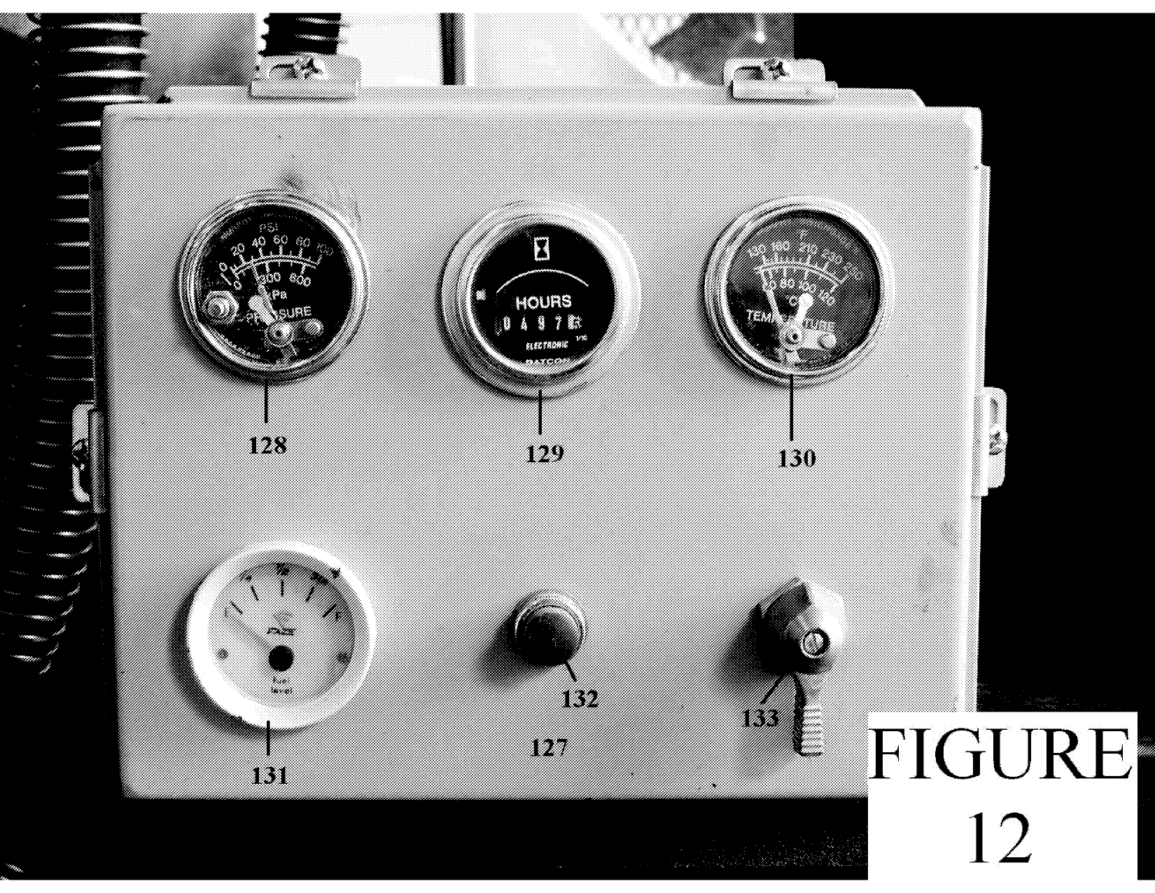

FIG. 12 is a photograph of one embodiment of the portable cooling system, revealing the engine control center 127 with various gauges and buttons, from top left to bottom right, the oil pressure gauge 128, the engine operating hours gauge 129, the engine temperature gauge 130, the engine fuel gauge 131, the engine start button 132, and the power switch 133.

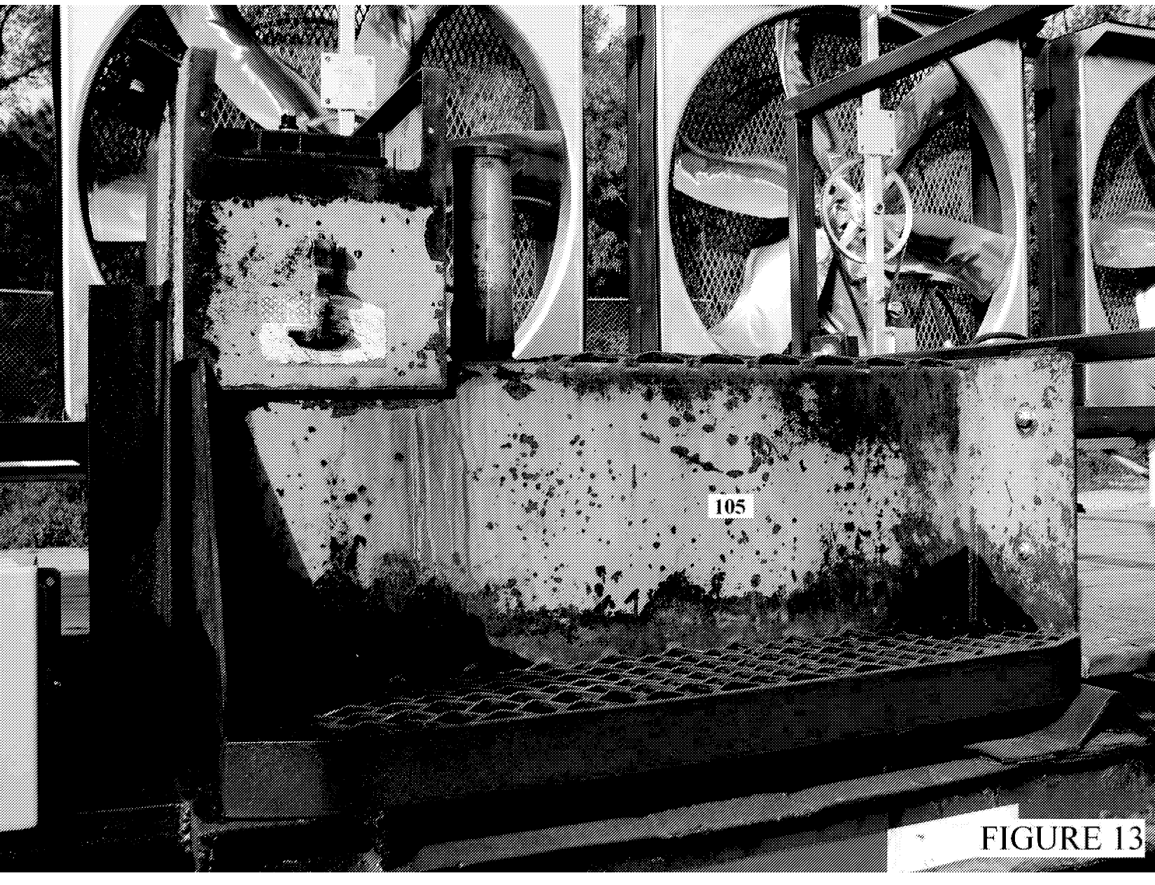

FIG. 13 is a photograph of one embodiment of the portable cooling system viewed from the side from which air and cooling liquid is blown away from the viewer, revealing the diesel fuel tank and battery housing 105.

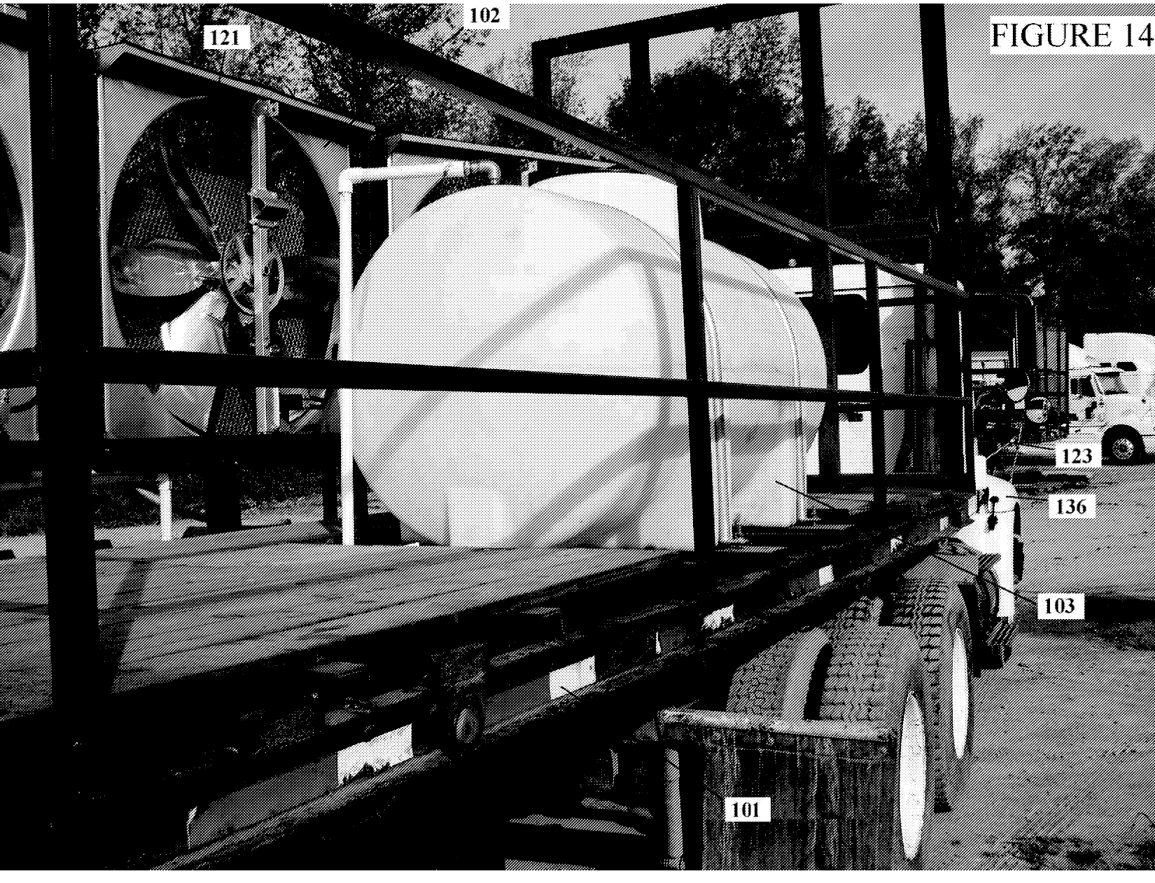

FIG. 14 is a photograph of one embodiment of the portable cooling system viewed from the side from which air and cooling liquid is blown away from the viewer, revealing the cooling liquid storage tank 103, the back of the fans 102, sprayer piping 121, and the truck 136 attached to the trailer 101 at the front 123.

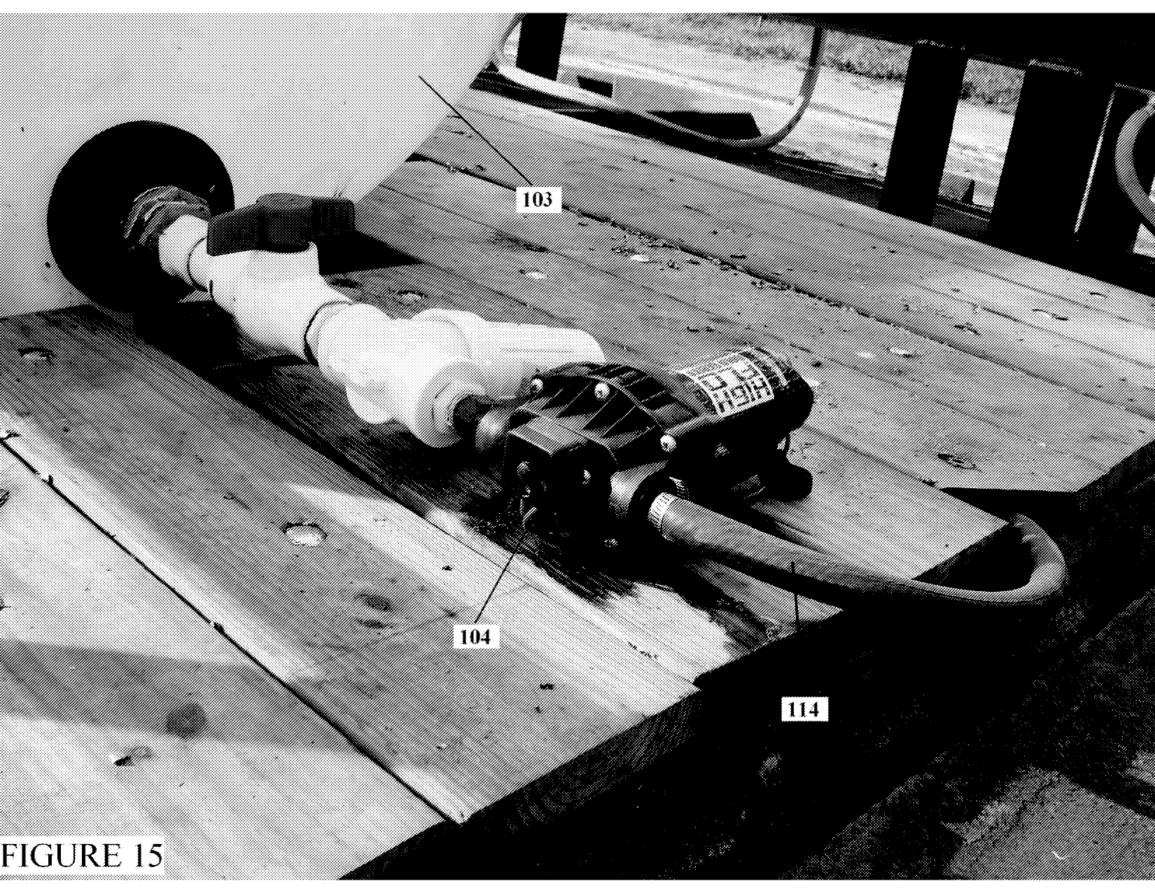

FIG. 15 is a photograph of one embodiment of the portable cooling system, revealing the cooling liquid pump 104 for the supplying liquid to the nozzles 115 located throughout the cooling liquid sprayer piping 121 on the face cage of each fan by way of cooling liquid lines 114 from the tank 103 to the nozzles 115.

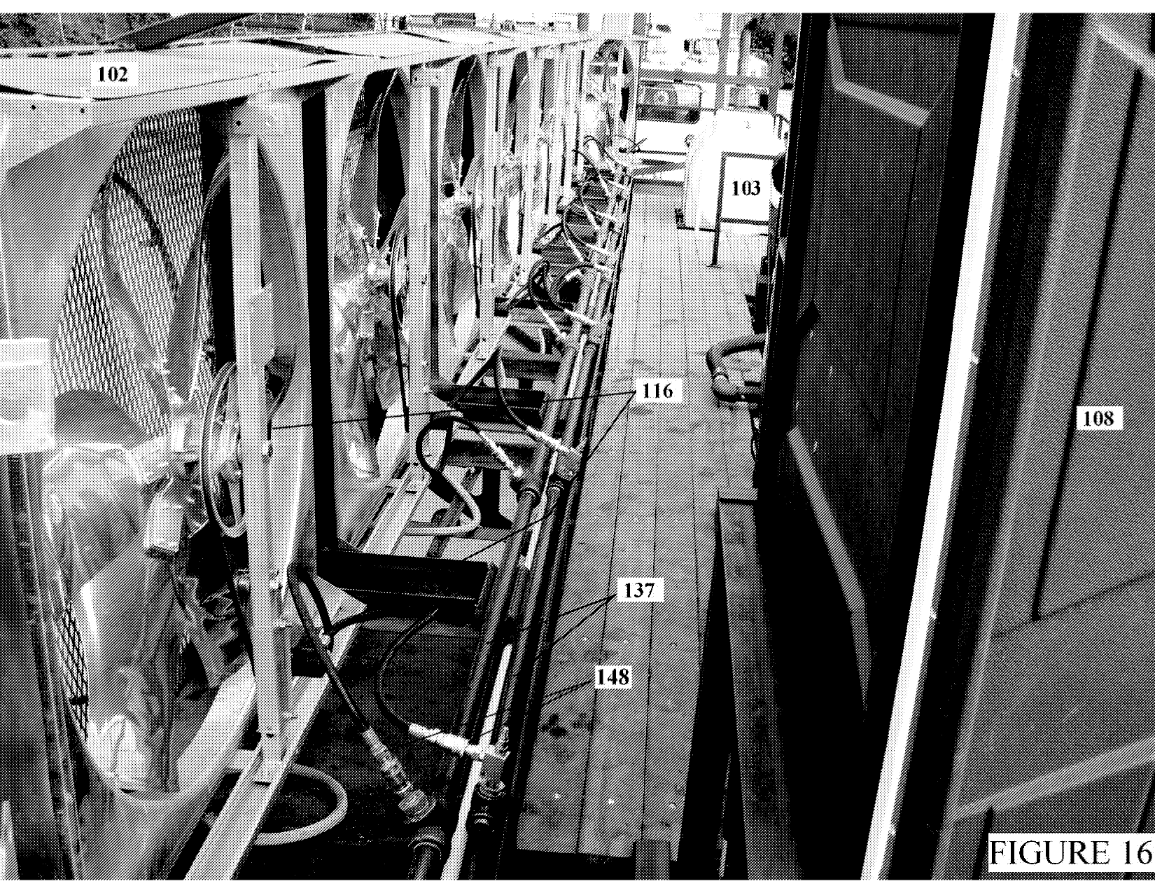

FIG. 16 is a photograph of one embodiment of the portable cooling system at a rear angled view between the back of the fans 102 and the portable toilet 108 on the right, revealing the hydraulic fan motor plumbing 137 for supplying hydraulic fluid under pressure to the fan motors 116 for powering the fans 102. The hydraulic piping would ideally include quick disconnect couplers 148 for each fan's 102 hydraulic lines. The quick disconnect assures that fans could separately be disconnected if maintenance problems arose or for any other desired reason. Controls in one embodiment may be provided on the control center 127 or elsewhere for separately controlling each fan 102. With separate controls for each fan, separate hydraulic or other power lines would ideally be provided.

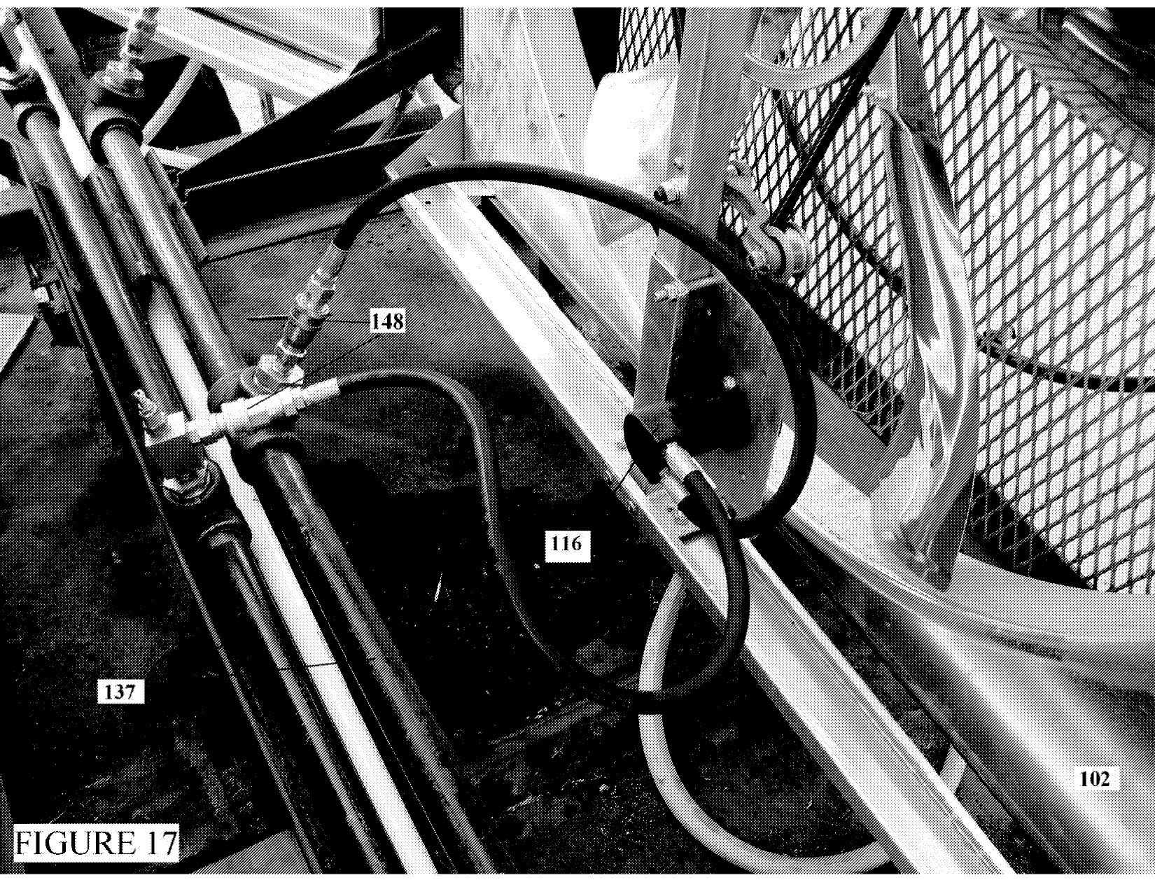

FIG. 17 is a photograph of one embodiment of the portable cooling system from the back of one fan 102, revealing a close-up view of the hydraulic fan motor plumbing 137 connected to the fan motor 116 via quick disconnect couplers 148 for powering the fan according to one embodiment.

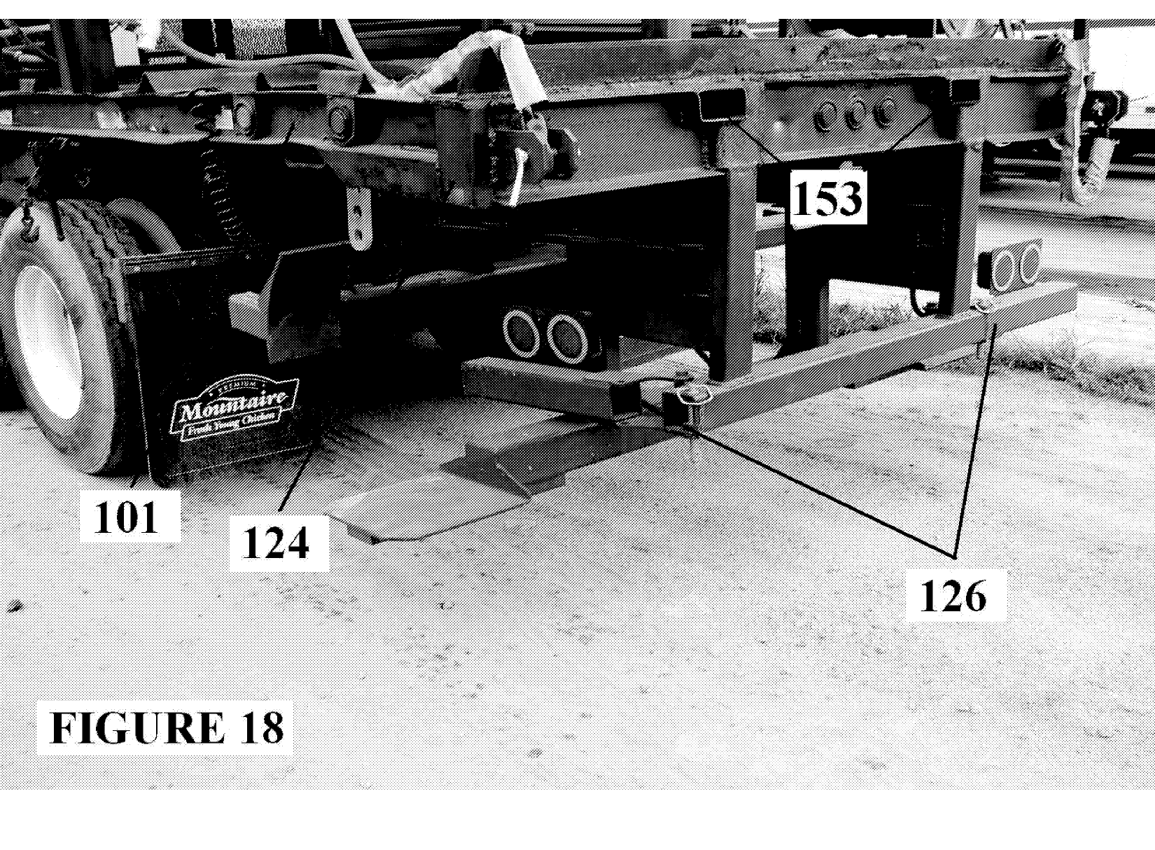

FIG. 18 is a photograph of one embodiment of the portable cooling system from the rear 124 of the trailer 101, revealing a close-up view of the folding ICC bumper 126 that provides access for loading a forklift on the back of the trailer also via the forklift fork tubing 153 on the rear of the trailer 124.

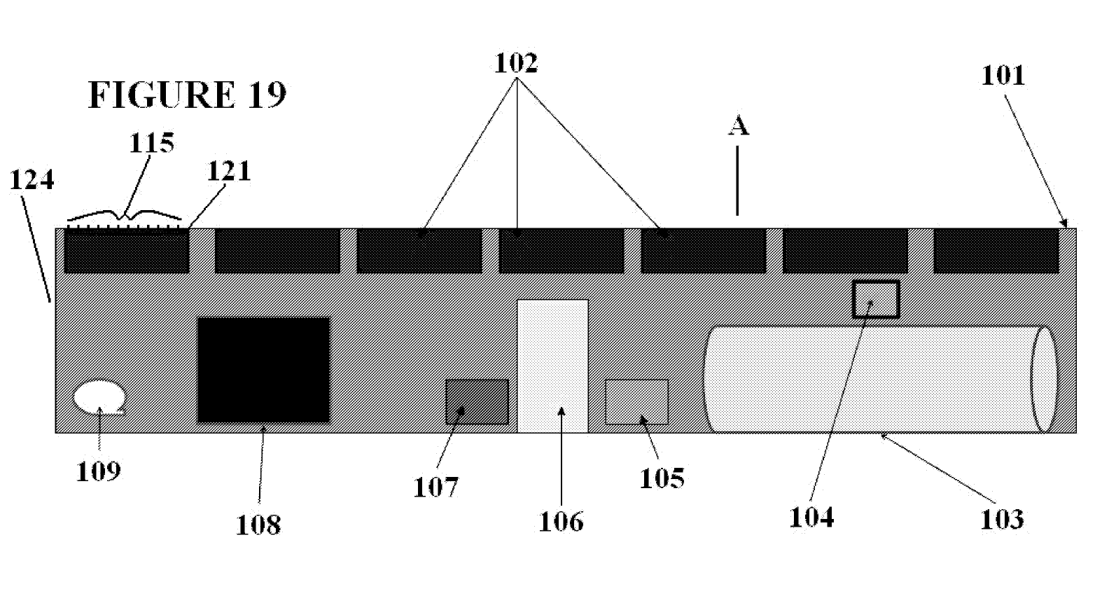

FIG. 19 is a top-down schematic illustration of one embodiment of the portable cooling system 100 mounted on a trailer 101 with a forward 123 and rear 124 sections. FIG. 19 reveals several fans 102 with the cooling liquid sprayer piping 121 on the face cage of each fan 102 that propel air and cooling liquid in the general direction A where a breadth of flow covers at least the length of the trailer 101 (or greater with angled fans at the forward 123 and rear 124 sections). In one embodiment, the fans 102 proximate the forward 123 and rear 124 sections (or any other fans that are desired to be adjustable) may be mounted or arranged on swivel mounts to allow an operator to manually, mechanically, or electrically control movement and angle of such fans to adjust the coverage of such fluid generated therefrom.

The piping 121 includes a series of nozzles 115 for delivering cooling liquid into the flow or air generated by the fans 102. Also shown is the cooling liquid supply hose reel 109, the portable toilet 108, a hydraulic storage tank 107, the engine 106, the fuel tank and battery 105, a cooling liquid holding tank 103 and cooling liquid pump 104. The trailer is equipped with a portable restroom 108 to be used by farm workers and/or catch crews.

A system of the type shown schematically in FIG. 19 is employed where each fan 102 flows 48,000 CFM X 9 fans=432,000 Cubic feet of air per minute. Air velocity would ideally be above 8 mph at 20 feet distance from the trailer. The ambient temperature in the fan area will be lowered between 30 to 40 degrees. The on-board cooling liquid tank 103 can hold at least 325 gallons of tap water which will supply the misting system for at least five hours of operation. The hose reel 109 on the rear 124 allows for refill of the tank 103 from any standard water source.

The hydraulic system operates at 1,800 psi under full load. The hydraulic piping and hoses are rated at 4,000 psi which will ensure long life of the hydraulic system with no plumbing problems.

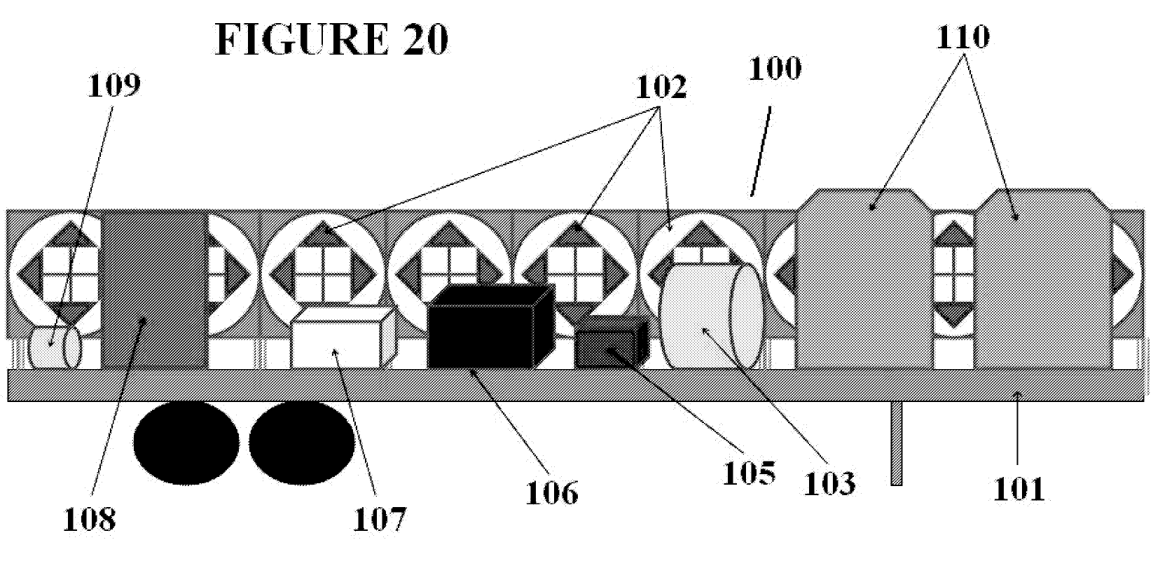

FIG. 20 is a back-side schematic illustration of one embodiment of the portable cooling system 100 mounted on a trailer 101 with a forward 123 and rear 124 sections. FIG. 20 reveals the back of several fans 102, the cooling liquid supply hose reel 109, the portable toilet 108, a hydraulic storage tank 107, the engine 106, the fuel tank and battery compartment 105, the cooling liquid holding tank 103, and two fire fans 110 for possibly putting out any engine fire or the like.

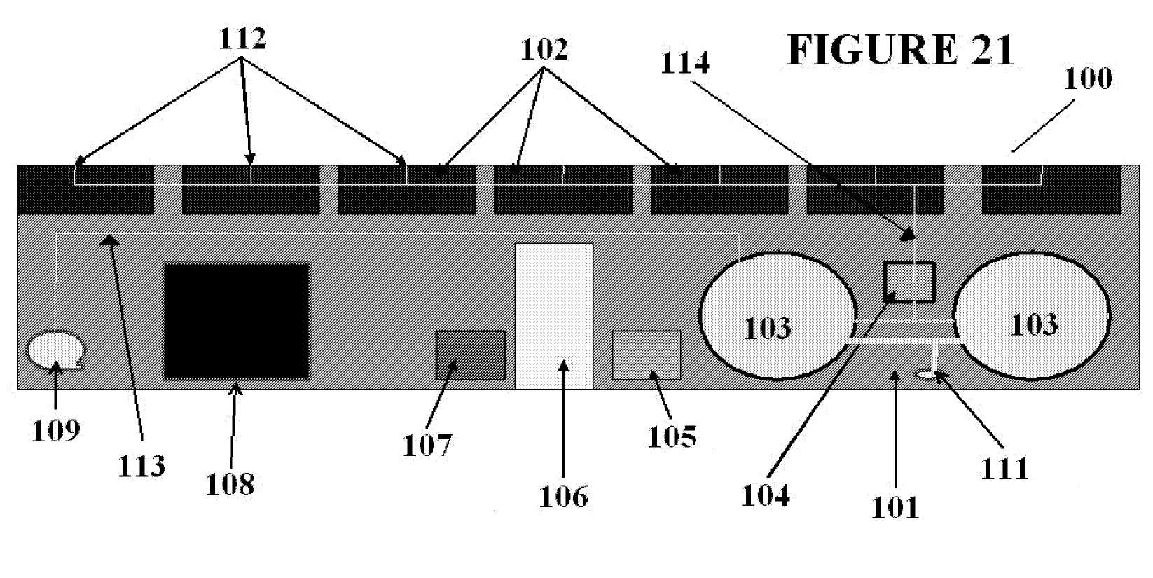

FIG. 21 is another top-down schematic illustration of one embodiment of the portable cooling system 100 mounted on a trailer 101 revealing a cooling liquid supply line 113 from the cooling liquid supply hose reel 109 to the first of two cooling liquid holding tanks 103, a quick fill connection 111 for filing one of the two tanks 103, and a cooling liquid distribution line 114 from the cooling liquid pump 104 to the nozzles 115 on each fan 102. The 3 or 4 inch quick fill connection 111 can be installed and used if cooling liquid supply is available, reducing the tank refill time dramatically. Alternatively, on farms with low water tables or even a broken water supply, trailers can be out fitted with a larger cooling liquid tank or tanks suitable for prolonged periods of operation. The trailer 101 pictured in FIG. 21 shows the cooling liquid plumbing schematic which allows the rear mounted hose reel 109 to fill the forward mounted cooling liquid holding tanks

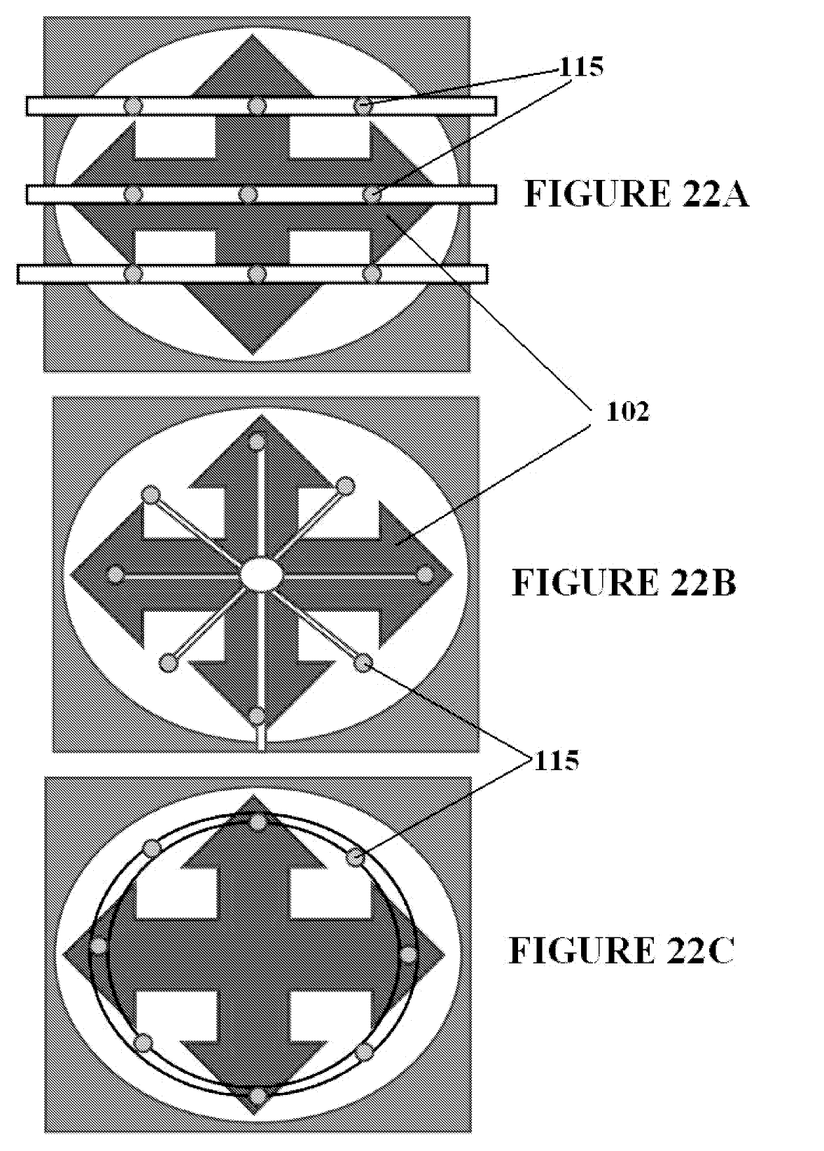

FIGS. 22A-22C show various patterns of the sprayer piping with nozzles. The pattern in FIG. 22A is described as a pipe design with relatively parallel sprayer piping 121. The pattern in FIG. 22B is described as a star or finger design. The pattern in FIG. 22C is described as a ring design, and is the best mode of the present invention since the sprayer piping 121 is one continuous unit, does not require separate pieces, has few joint pieces in the piping, and provides a broad coverage area relative to the same shape of the fans 102 with nozzles 115 dispersed evenly. The water pump retrieves water from the holding tank 103 and pumps the water through piping 114 under pressure to the spray nozzles or fogger nozzles 115 which inject water into the fans air stream.

The spay nozzles 115 can be configured in several different ways. The nozzles 115 may be positioned around the piping and can include both spray nozzles and mister nozzles. The spray nozzles are used when more water is needed such as soaking the animals. The mister or fogger nozzles are used when less water is needed but the evaporative cooling is still desired. Adjustable nozzles are also desired to vary the flow of cooling liquid with ease.

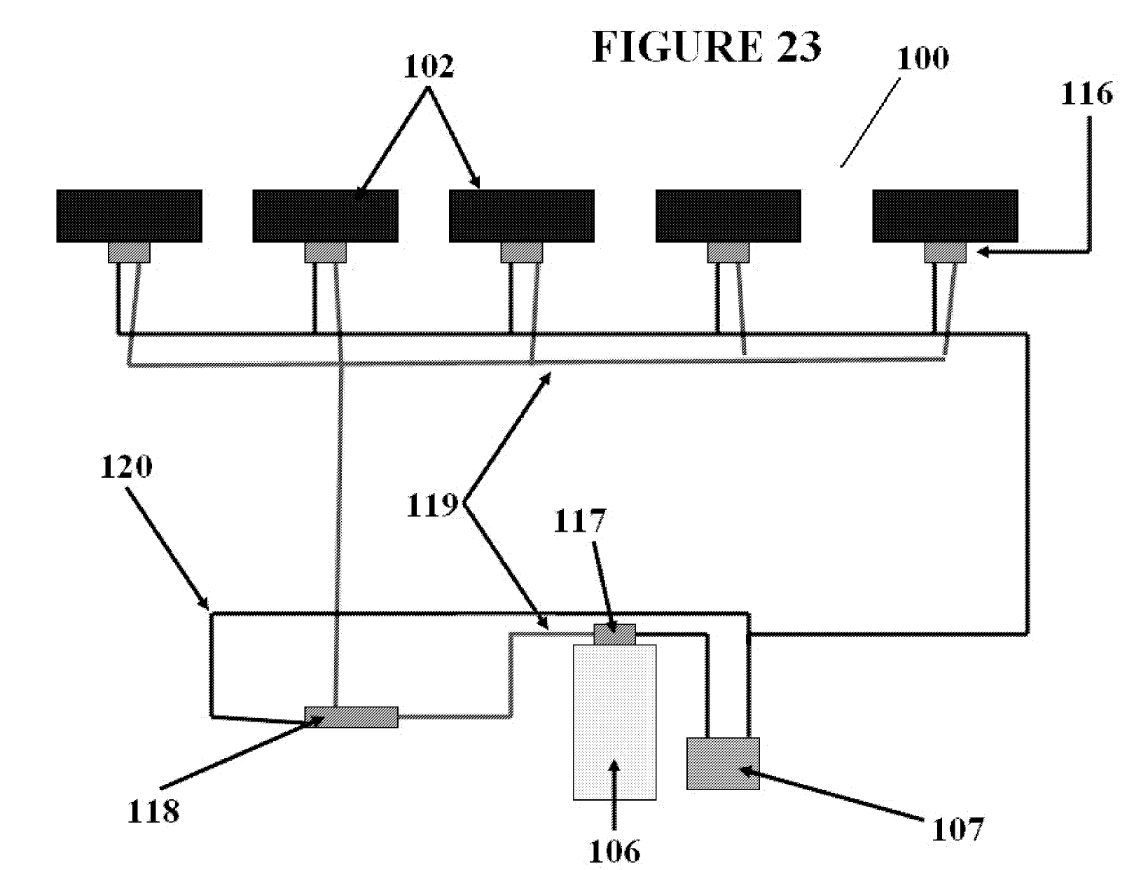

FIG. 23 reveals the system 100 with the design and workings schematic of a single hydraulic control which operates all fans 102 with one control manifold 118, utilizing high pressure lines 119 and low pressure lines 120 that pull hydraulic fluid from reservoir 107, where the engine 106 drives power to the hydraulic pump 117.

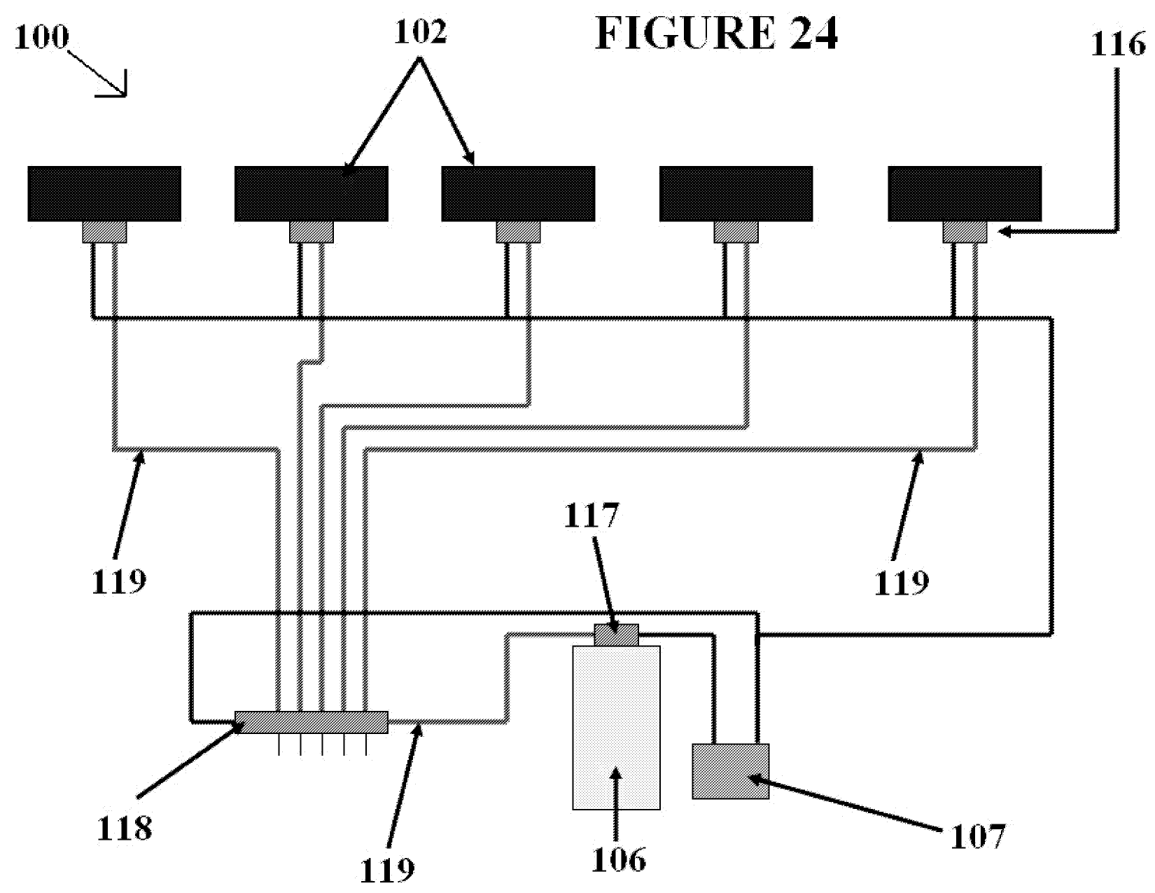

FIG. 24 reveals the system 100 with the design and workings schematic of a multiple hydraulic control which operates each fan 102 individually through one control manifold 118 with a high pressure hydraulic lines 119 for each motor 116 of each fan 102.

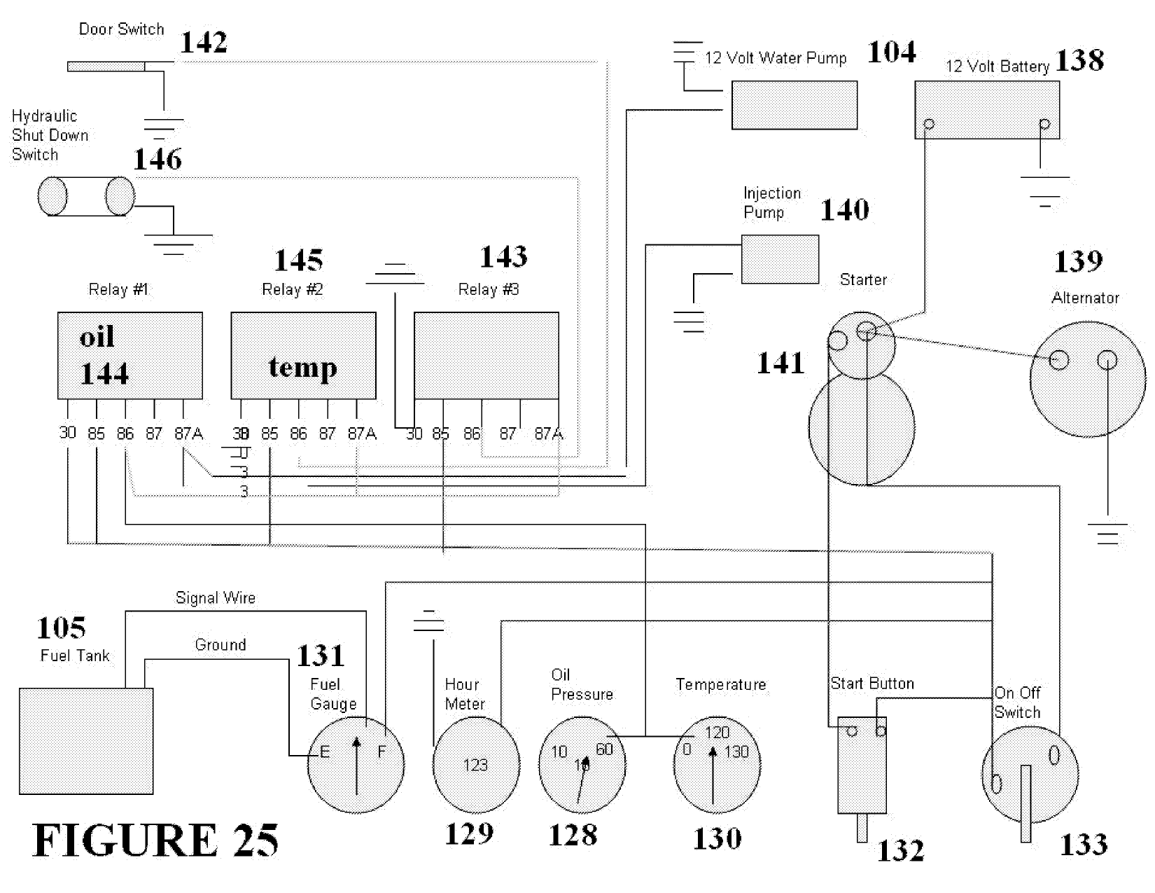

FIG. 25 details the electrical wiring schematic one embodiment which operates the system 100, includes a battery 139 which can be located in the same housing next to the fuel tank 105, starter 141, alternator and charging circuit 139, a starter button 132, ignition on/off switch 133, and an injection pump circuit 140. Optionally provided is a maintenance gate 134 with a safety kill switch circuit 142 and relay 143 to cut off power to the fans 102 via a hydraulic shut down switch 146 when the maintenance gate 134 is opened for safety purposes. The system 100 includes a fuel tank 105 that also may optionally include a fuel gauge 131 and an engine hour meter gauge 129. Additionally, an oil pressure gauge 128 attached to a relay 144 and engine temperature gauge 130 attached to a relay 145 prevent engine damage from over heating or loss of oil pressure, wherein the two relays 144 and 145 each can be activated to shut down the system 100. The power supply for the 12 cooling liquid pump if used instead of the hydraulic cooling liquid pump

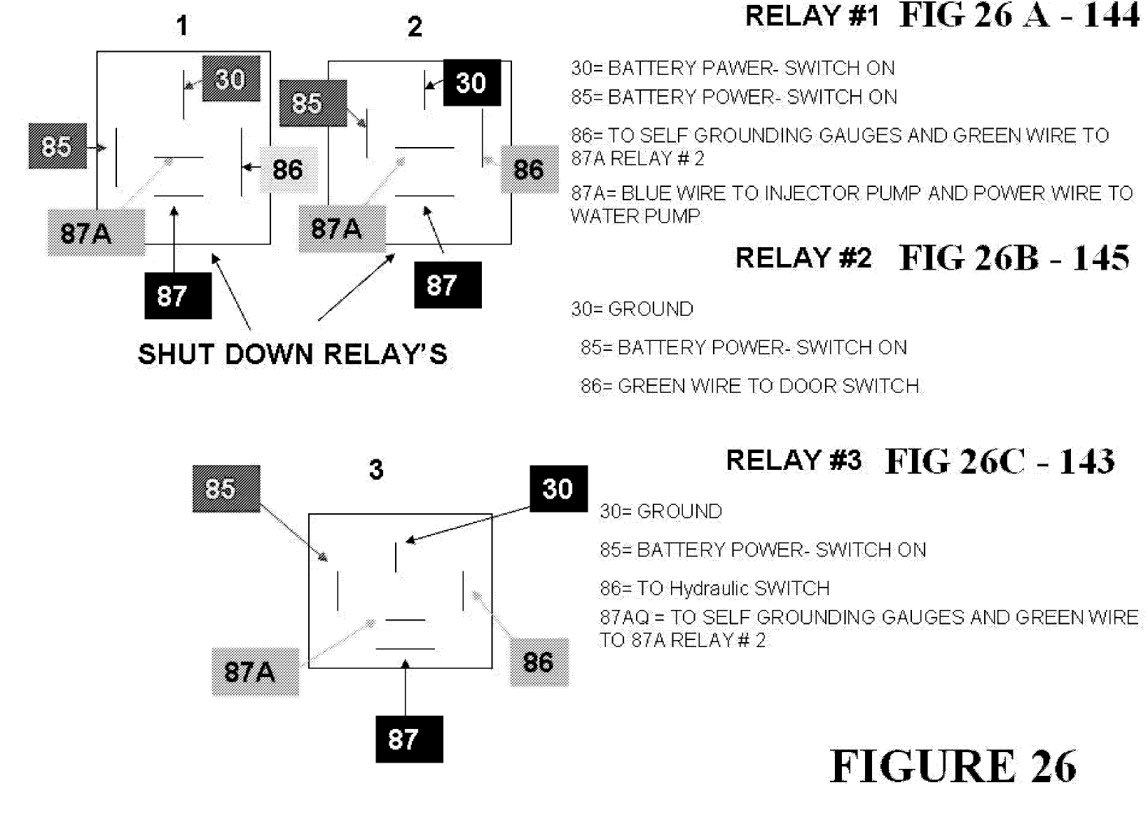

FIGS. 26A-26C show the details of relays 144, 145 and 143, respectively. Relay 144 FIG. 26 A and relay 145 in FIG. 26B are engine shut down relays, wherein if the oil pressure or temperature get out of an acceptable range, a relay for each will shut the engine 106 down. Relay 143 in FIG. 26C will shut down the hydraulic pump 117, whereby the fans 102 and optionally the cooling liquid pump 104 are also shut down when the maintenance gate 134 is opened triggering the maintenance door kill switch 142 that is attached to the door relay 143.

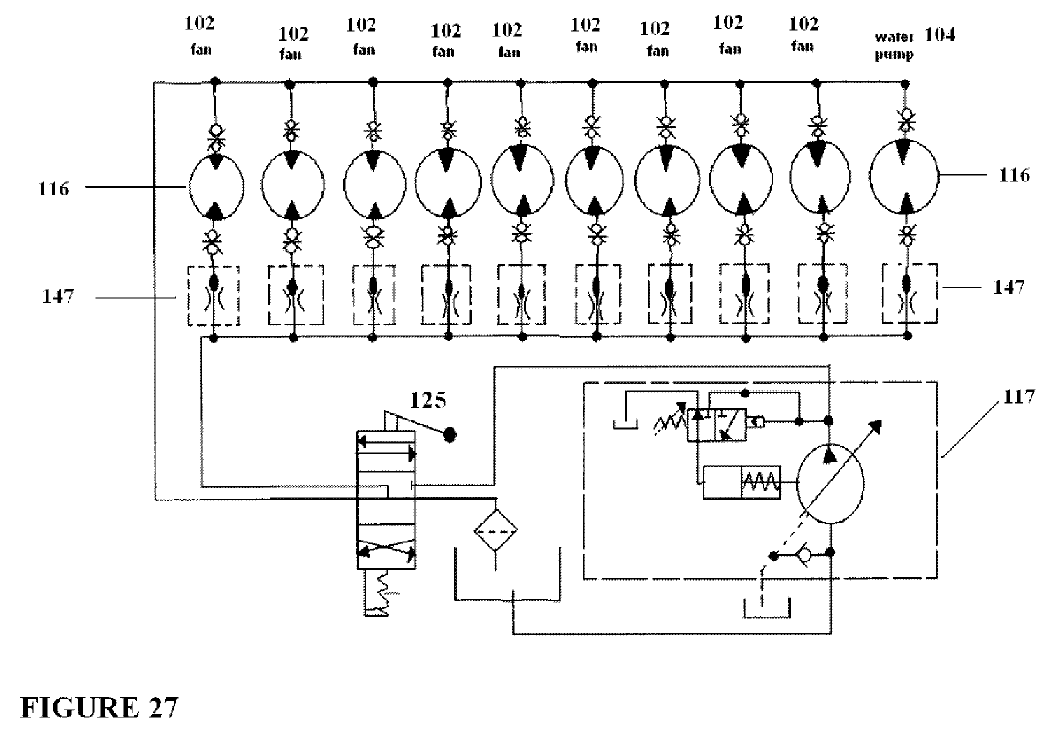

FIG. 27 is a hydraulic schematic drawing for a single on/off hand control 125 which operates all fans 102 simultaneously. The drawing includes the hydraulic pump 117, hand control valve 125, motors 116, fan speed control regulators 147, all within the piping flow chart of FIG. 27.

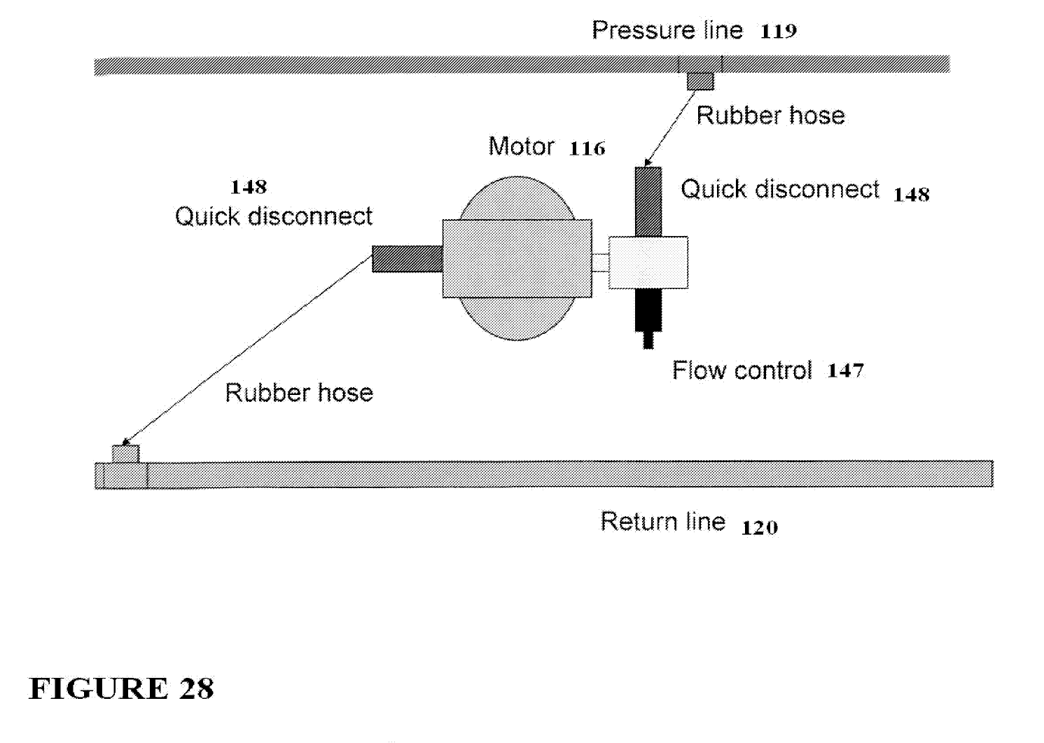

FIG. 28 is a schematic drawing of a hydraulic fan motor 116 that is powered by hydraulic fluid from the hydraulic pump 117 through high pressure lines 119, connected via a quick disconnect hydraulic coupler 148 to the fan motor 116 by way of a fan speed flow control regulator 147, whereby the hydraulic fluid is returned via a low pressure line 120 through another quick disconnect hydraulic coupler 148. The quick disconnect couplers allow for removal, repair or replacement of the fans 102 and/or fan motors 116 when necessary.

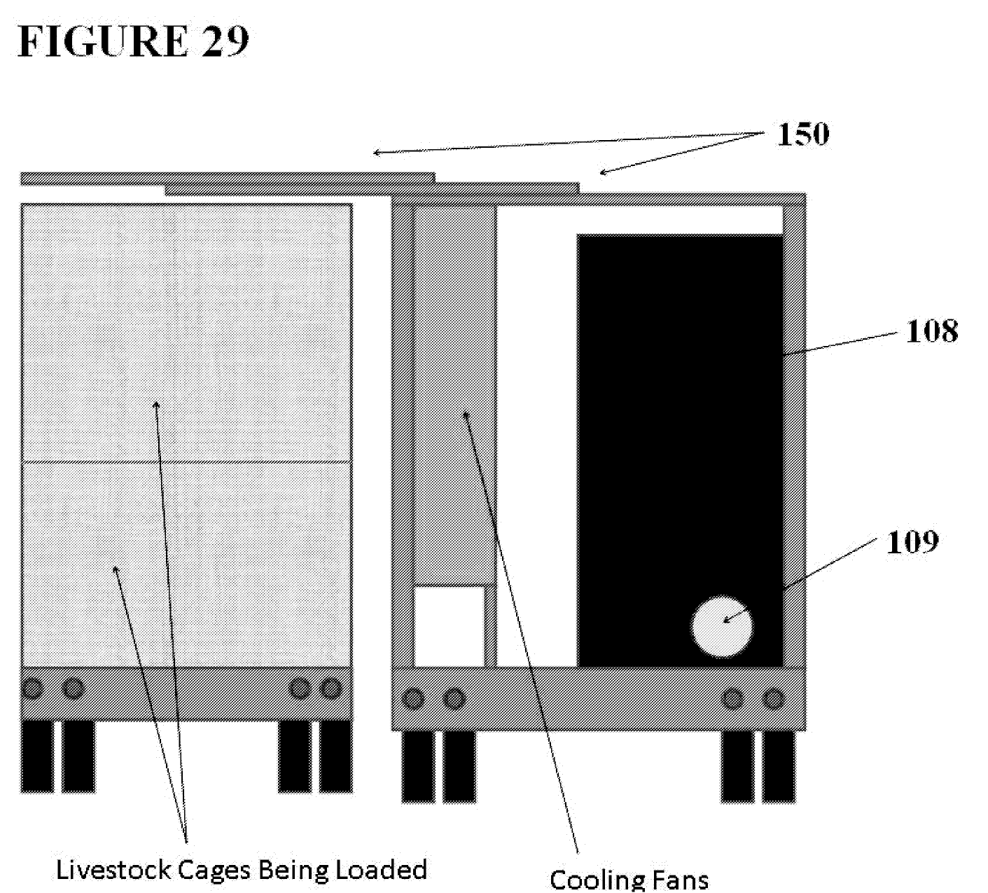

FIG. 29 is another embodiment of the present system that employs at least one sliding canopy 150 to reduce the thermal exposure to sunlight of the livestock cages 151 being loaded onto the transport trailer 153.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A portable cooling system, comprising:
a mobile carrier;
a plurality of fans mounted on the carrier, wherein at least one of said plurality of fans is arranged non-parallel to at least one other of said plurality of fans;
at least one motor for driving each of said plurality of fans;
a power source for driving the at least one motor; and
a liquid source arranged to supply liquid to an air stream generated in operation of said plurality of fans.

2. The system of claim 1, wherein the power source comprises a hydralic power source.

3. The system of claim 2, wherein an engine drives the hydraulic power source.

4. The system of claim 3, wherein the engine comprises a diesel engine.

5. The system of claim 2, wherein the hydraulic power source is separately coupled to each of said plurality of fans.

6. The system of claim 1, further comprising a canopy arranged to cover a portable trailer.

7. The system of claim 1, further comprising a portable liquid storage unit.

8. The system of claim 1, further comprising a pump for supplying the liquid.

9. The system of claim 1, wherein the mobile carrier comprises a trailer-mounted assembly.

10. A portable cooling system, comprising:
a mobile carrier;
at least one motive ambient gas driver generating in operation an ambient gas flow stream, wherein said at least one first motive ambient gas driver is mounted on the carrier;
a motor for driving the at least one motive ambient gas driver;
a power source for driving the motor; and
a liquid source arranged in a circular shape to supply liquid to an air stream generated in operation of said at least one motive ambient gas driver.

11. The system of claim 10, wherein the at least one motive ambient gas driver comprises a venturi, nebulizer, eductor, blower, or turbine.

12. The system of claim 10, wherein the mobile carrier comprises a truck-trailer assembly.

13. A method of transporting poultry comprising:
providing a mobile cooling system mounted on a mobile carrier, the mobile cooling system comprising a first motor for driving at least one first motive ambient gas driver that is non-parallel to a second motive ambient gas driver driven by a second motor; a power source for driving the first and second motors; a liquid source arranged to supply liquid to an air stream generated in operation of said at least one first and second motive ambient gas drivers; and
activating the mobile cooling system in proximity to the poultry.

14. A method of reducing poultry loss incident to heat during transport, comprising:
providing a mobile cooling system mounted on a mobile carrier, the mobile cooling system comprising a motor for driving the at least one motive ambient gas driver;
a power source for driving the motor; a liquid source arranged to supply liquid to an air stream generated in operation of said at least one motive ambient gas driver, wherein the air stream generated in operation of said at least one motive ambient gas driver is of at least the length of the mobile carrier; and
activating the mobile cooling system during loading and unloading of said poultry.
